(19) United States
(12) Patent Application Publication
(10) Pub. No.: US 2012/0054001 A1
(43) Pub. Date: Mar. 1, 2012

(54) Geo-fenced Virtual Scratchcard

(75) Inventors: Aleksandar Zivkovic, North York (CA); Marvin Igelman, Thornhill (CA)

(73) Assignee: POYNT CORPORATION, Calgary (CA)

(21) Appl. No.: 13/215,467

(22) Filed: Aug. 23, 2011

Related U.S. Application Data
(60) Provisional application No. 61/376,756, filed on Aug. 25, 2010.

(51) Int. Cl. G06Q 30/02

(52) U.S. Cl. 705/14.1; 705/14.57

(57) ABSTRACT

A method of providing a geo-fenced advertisement to a mobile communications device is provided. The advertisement has an associated virtual scratchcard offer. The scratchcard is displayed only when the mobile communications device is less than a first predefined distance from a location of a business. The offer is revealed only when a user performs a virtual scratching function with the mobile communications device while the mobile communications device is less than a second predefined distance from the location of the business. The second predefined distance is less than the first predefined distance.

### CROSS REFERENCE TO RELATED APPLICATIONS

This application claims the benefit of U.S. Provisional Patent Application No. 61/376,756, filed Aug. 25, 2010, titled “Geo-fenced Virtual Scratchcard,” the entire contents of which are hereby incorporated by reference herein, for all purposes.

### TECHNICAL FIELD

The present invention relates to advertising systems and methods and, more particularly, to location-based advertising systems and methods.

### BACKGROUND ART

Location-based advertising (LBA) is known. However, known LBA systems have limitations, in that these systems display advertisements whenever a user is within a predetermined distance of a fixed location, such as the location of a merchant. Such systems lead to confusion and disinterest by users, because the advertising messages do not motivate the users to move toward the merchant's location.

### SUMMARY OF EMBODIMENTS

An embodiment of the present invention provides a computer-implemented method of displaying a geo-fenced advertisement on a wireless mobile communications device of a user. The advertisement is associated with a business, and the business has an associated business location. The method includes automatically receiving information about a geographic location of the mobile communication device. While the mobile communications device is within a first predefined distance of the business location, a first version of the advertisement is automatically caused to be displayed on the mobile communications device. While the mobile communications device is within a second predefined distance, less than the first predefined distance, of the business location, a second version of the advertisement, different than the first version of the advertisement, is automatically caused to be displayed on the mobile communications device.

The term “while” does not necessarily mean for the entire time. For example, the first version of the advertisement may be displayed for only a portion of the time the mobile communications device is within the first predetermined distance of the business location. Furthermore, the distance between the mobile communications device and the business location may be measured in two or three dimensions. The mobile communications device is typically a wireless communications device, such as a mobile telephone.

Optionally, automatically causing display of the first version of the advertisement may include automatically causing display of the first version of the advertisement while the mobile communications device is both within the first predefined distance of the business location and at least the second predefined distance from the business location. For example, the first version of the advertisement may be displayed while the mobile communications device is within a band surrounding the business location, but not while the mobile communications device is within the second predetermined distance of the business location.

Optionally, automatically causing display of the first version of the advertisement may include automatically causing display of the first version of the advertisement only while the mobile communications device is within the first predefined distance of the business location. Similarly, automatically causing display of the second version of the advertisement may include automatically causing display of the second version of the advertisement only while the mobile communications device is within the second predefined distance of the business location.

Optionally, while the mobile communications device is within a predefined redemption area, the user of the mobile communications device may be automatically notified. That is, there may be automatically caused notification of the user of the mobile communications device. This notification may be in the form of a visual and/or audio signal.

Optionally, while the mobile communications device is within the second predefined distance of the business location, an offer associated with the advertisement may be automatically revealed at the mobile communications device.

Optionally, while the mobile communications device is within the second predefined distance of the business location, if there is received a signal resulting from a user input on the mobile communication device in association with display of the second version of the advertisement, there may be automatically caused revelation, at the mobile communications device, of an offer associated with the advertisement, in response to receiving the signal.

Optionally, causing display of the second version of the advertisement may include causing display, on the mobile communication device, of a virtual scratchcard. In addition, causing revelation of the offer comprises, in response to the user input, may automatically cause alteration of at least a portion of the displayed virtual scratchcard, so as to reveal the offer.

Optionally, automatically causing revelation of the offer may include revealing the offer only in response to receiving the signal.

Optionally, automatically causing revelation of the offer may include revealing the offer only in response to receiving the signal while the mobile communications device is within the second predefined distance of the business location.

Optionally, receiving the signal resulting from the user input on the mobile communication device may include receiving a signal resulting from a wiping gesture performed on the mobile communication device.

Optionally, causing revelation of the offer may include causing revelation of an offer that is valid only if the user provides an input into the mobile communication device while the mobile communications device is within the second predefined distance of the business location.

Optionally, information about the advertisement may be stored in a memory of the mobile communications device. Automatically causing the display of the second version of the advertisement may include automatically causing display of the second version of the advertisement in response to the user accessing the stored information about the advertisement. Storing the information about the advertisement in the memory of the mobile communications device may include creation of a bookmark in the memory, and automatically causing display of the second version of the advertisement in response to the user accessing the stored information about the advertisement may include automatically causing display of the second version of the advertisement in response to the user accessing the bookmark.

Optionally, the associated business location may be received, by a computer, during an initialization phase, and the received associated business location may be stored in a database. After the initialization phase, information about at least one of a selected product and a selected service and price information associated with the at least one of the selected product and the selected service may be received via an automated telephone interactive voice response (IVR) system. The advertisement may be automatically generated using the stored associated business location, the received information about the at least one of the selected product and the selected service and the received associated price information. Information about the generated advertisement may be stored in the database. Subsequently, the stored information about the generated advertisement may be used to cause the display of the first and second versions of the advertisement.

Another embodiment of the present invention provides a tangible, non-transitory computer-readable medium having computer code stored thereon for displaying a geo-fenced advertisement on a wireless mobile communications device of a user. The advertisement is associated with a business having an associated business location. The computer code includes computer code configured to automatically receive information about a geographic location of the mobile communication device. The computer code also includes computer code configured to, while the mobile communications device is within a first predefined distance of the business location, automatically cause display, on the mobile communications device, of a first version of the advertisement. The computer code also includes computer code configured to automatically cause display, on the mobile communications device, of a second version of the advertisement, different than the first version of the advertisement, while the mobile communications device is within a second predefined distance, less than the first predefined distance, of the business location.

Optionally, the computer-readable medium may also include computer code configured to perform any of the methods described above.

Optionally, the computer code configured to automatically cause display of the first version of the advertisement may include computer code configured to automatically cause display of the first version of the advertisement while the mobile communications device is both within the first predefined distance of the business location and at least the second predefined distance from the business location. For example, the first version of the advertisement may be displayed while the mobile communications device is within a band surrounding the business location, but not while the mobile communications device is within the second predetermined distance of the business location.

Optionally, the computer code configured to automatically cause display of the first version of the advertisement may include computer code configured to automatically cause display of the first version of the advertisement only while the mobile communications device is within the first predefined distance of the business location. Similarly, the computer code configured to automatically cause display of the second version of the advertisement may include computer code configured to automatically cause display of the second version of the advertisement only while the mobile communications device is within the second predefined distance of the business location.

Optionally, the computer-readable medium may include computer code configured to automatically notify the user of the mobile communications device, while the mobile communications device is within a predefined redemption area. That is, there may be automatically caused notification of the user of the mobile communications device. This notification may be in the form of a visual and/or audio signal.

Optionally, the computer-readable medium may include computer code configured to automatically reveal, at the mobile communications device, an offer associated with the advertisement, while the mobile communications device is within the second predefined distance of the business location.

Optionally, the computer-readable medium may include computer code configured to, in response to receiving a signal resulting from a user input on the mobile communication device in association with display of the second version of the advertisement and while the mobile communications device is within the second predefined distance of the business location, automatically cause revelation at the mobile communications device of an offer associated with the advertisement.

Optionally, the computer code configured to cause display of the second version of the advertisement may include computer code configured to cause display, on the mobile communication device, of a virtual scratchcard. In addition, computer code configured to cause revelation of the offer comprises, in response to the user input, may include computer code configured to automatically cause alteration of at least a portion of the displayed virtual scratchcard, so as to reveal the offer.

Optionally, the computer code configured to automatically cause revelation of the offer may include computer code configured to reveal the offer only in response to receiving the signal.

Optionally, the computer code configured to automatically cause revelation of the offer may include computer code configured to reveal the offer only in response to receiving the signal while the mobile communications device is within the second predefined distance of the business location.

Optionally, the computer code configured to receive the signal resulting from the user input on the mobile communication device may include computer code configured to receive a signal resulting from a wiping gesture performed on the mobile communication device.

Optionally, the computer code configured to cause revelation of the offer may include computer code configured to cause revelation of an offer that is valid only if the user provides an input into the mobile communication device while the mobile communications device is within the second predefined distance of the business location.

Optionally, the computer-readable medium may include computer code configured to store information about the advertisement in a memory of the mobile communications device. The computer code configured to automatically cause the display of the second version of the advertisement may include computer code configured to automatically cause display of the second version of the advertisement in response to the user accessing the stored information about the advertisement. The computer code configured to store the information about the advertisement in the memory of the mobile communications device may include computer code configured to cause creation of a bookmark in the memory, and the computer code configured to automatically cause display of the second version of the advertisement in response to the user accessing the stored information about the advertisement may include computer code configured to automatically cause display of the second version of the advertisement in response to the user accessing the bookmark.

Optionally, the computer-readable medium may include computer code configured to receive the associated business location, by a computer, during an initialization phase and store the received associated business location in a database. The computer code may be configured to, after the initialization phase, receive information about at least one of a selected product and a selected service and price information associated with the at least one of the selected product and the selected service, via an automated telephone interactive voice response (IVR) system. The computer-readable medium may include computer code configured to automatically generate the advertisement using the stored associated business location, the received information about the at least one of the selected product and the selected service and the received associated price information. The computer code may be configured to store information about the generated advertisement in the database. The computer code may be configured to subsequently use the stored information about the generated advertisement to cause the display of the first and second versions of the advertisement.

Yet another embodiment of the present invention provides a system for displaying a geo-fenced advertisement on a wireless mobile communications device of a user. The advertisement may be associated with a business having an associated business location. The system includes a location module configured to receive information about a geographic location of the mobile communication device. An advertisement module is configured to, while the mobile communications device is within a first predefined distance of the business location, automatically cause display, on the mobile communications device, of a first version of the advertisement. The advertisement module is also configured to, while the mobile communications device is within a second predefined distance, less than the first predefined distance, of the business location, automatically cause display, on the mobile communications device, of a second version of the advertisement, different than the first version of the advertisement.

Optionally, the system may also include elements configured to perform any of the methods described above or include any of the functionality described above, with respect to the computer code of the computer-readable medium.

Optionally, the advertisement module may be configured to automatically cause display of the first version of the advertisement while the mobile communications device is both within the first predefined distance of the business location and at least the second predefined distance from the business location. For example, the first version of the advertisement may be displayed while the mobile communications device is within a band surrounding the business location, but not while the mobile communications device is within the second predetermined distance of the business location.

Optionally, the advertisement module may be configured to automatically cause display of the first version of the advertisement only while the mobile communications device is within the first predefined distance of the business location. Similarly, the advertisement module may be configured to automatically cause display of the second version of the advertisement only while the mobile communications device is within the second predefined distance of the business location.

Optionally, the advertisement module may be configured to automatically notify the user of the mobile communications device, while the mobile communications device is within a predefined redemption area. That is, there may be automatically caused notification of the user of the mobile communications device. This notification may be in the form of a visual and/or audio signal.

Optionally, the advertisement module may be configured to automatically reveal, at the mobile communications device, an offer associated with the advertisement, while the mobile communications device is within the second predefined distance of the business location.

Optionally, the advertisement module may be configured to, in response to receiving a signal resulting from a user input on the mobile communication device in association with display of the second version of the advertisement and while the mobile communications device is within the second predefined distance of the business location, automatically cause revelation at the mobile communications device of an offer associated with the advertisement.

Optionally, the advertisement module may be configured to cause display, on the mobile communication device, of a virtual scratchcard. In addition, the advertisement module may be configured to, in response to the user input, automatically cause alteration of at least a portion of the displayed virtual scratchcard, so as to reveal the offer.

Optionally, the advertisement module may be configured to reveal the offer only in response to receiving the signal.

Optionally, the advertisement module may be configured to reveal the offer only in response to receiving the signal while the mobile communications device is within the second predefined distance of the business location.

Optionally, the advertisement module may be configured to receive the signal resulting from the user input on the mobile communication device by receiving a signal resulting from a wiping gesture performed on the mobile communication device.

Optionally, the advertisement module may be configured to cause revelation of the offer by causing revelation of an offer that is valid only if the user provides an input into the mobile communication device while the mobile communications device is within the second predefined distance of the business location.

Optionally, the advertisement module may be configured to store information about the advertisement in a memory of the mobile communications device. The advertisement module may be configured to automatically cause the display of the second version of the advertisement by automatically causing display of the second version of the advertisement in response to the user accessing the stored information about the advertisement. The advertisement module may be configured to store the information about the advertisement in the memory of the mobile communications device by causing creation of a bookmark in the memory, and the advertisement module may be configured to automatically cause display of the second version of the advertisement in response to the user accessing the stored information about the advertisement by automatically causing display of the second version of the advertisement in response to the user accessing the bookmark.

Optionally, the advertisement module may be configured to receive the associated business location, by a computer, during an initialization phase and store the received associated business location in a database. The advertisement module may be configured to, after the initialization phase, receive information about at least one of a selected product and a selected service and price information associated with the at least one of the selected product and the selected service, via an automated telephone interactive voice response (IVR) system. The advertisement module may be configured to automatically generate the advertisement using the stored associated business location, the received information about the at least one of the selected product and the selected service and the received associated price information. The advertisement module may be configured to store information about the generated advertisement in the database. The advertisement module may be configured to subsequently use the stored information about the generated advertisement to cause the display of the first and second versions of the advertisement.

Optionally, the system may include a notification module configured to automatically cause notification of the user of the mobile communications device, while the mobile communications device is within a predefined redemption area.

Optionally, the advertisement module may be configured to automatically reveal, at the mobile communications device, an offer associated with the advertisement, while the mobile communications device is within the second predefined distance of the business location.

Optionally, the advertisement module may be configured to, while the mobile communications device is within the second predefined distance of the business location, receive a signal resulting from a user input on the mobile communication device in association with display of the second version of the advertisement. In addition, the advertisement module may be configured to, in response to receiving the signal, automatically cause revelation, at the mobile communications device, of an offer associated with the advertisement.

Optionally, the advertisement module may be configured to store information about the advertisement in a memory of the mobile communications device. In addition, the advertisement module may be configured to automatically cause the display of the second version of the advertisement by automatically causing display of the second version of the advertisement in response to the user accessing the stored information about the advertisement.

Optionally, the system may include an advertisement add module configured to receive, during an initialization phase, the associated business location and store the received associated business location in a database. The advertisement add module may be further configured to, after the initialization phase, receive, via an automated telephone interactive voice response (IVR) system, information about at least one of a selected product and a selected service and price information associated with the at least one of the selected product and the selected service. The advertisement module may be configured to automatically generate the advertisement using the stored associated business location, the received information about the at least one of the selected product and the selected service and the received associated price information. In addition, the advertisement module may be configured to store information about the generated advertisement in the database and subsequently use the stored information about the generated advertisement to cause the display of the first and second versions of the advertisement.

### BRIEF DESCRIPTION OF THE DRAWINGS

The invention will be more fully understood by referring to the following Detailed Description of Specific Embodiments in conjunction with the Drawings, of which:

FIG. 1 is a diagram of tiers for a geo-fenced advertisement, according to an embodiment of the present invention.

FIG. 2 is a diagram of an array of tiers for several geo-fenced advertisements similar to the embodiment of FIG. 1, according to an embodiment of the present invention.

FIGS. 3-11 are hypothetical screenshots from a mobile communications device with an advertisement, in accordance with an embodiment of the present invention.

FIG. 12 is an exemplary QR code for use in an embodiment of the present invention.

FIG. 13 is a hypothetical screenshot from a mobile communications device with an advertisement, in accordance with an embodiment of the present invention.

FIG. 14 is a schematic flowchart of a process for providing advertisements, according to an embodiment of the present invention.

FIG. 15 is hypothetical web form for signing a merchant up to place advertisements, according to an embodiment of the present invention.

FIG. 16 is a selection menu for use in the web form of FIG. 15.

FIG. 17 is a selection menu for use in the web form of FIG. 15.

FIGS. 18A-18E form a schematic diagram describing options for a user console for use, in accordance with embodiments of the present invention.

FIGS. 19A-19D form a schematic flow chart defining exemplary processes for determining details about how ads are served, in accordance with embodiments of the present invention.

FIGS. 20A-20E form a schematic flow chart showing possible interactions of a user with an advertisement, according to embodiments of the present invention.

FIG. 21 is a schematic flow chart for creating a new ad campaign, according to embodiments of the present invention.

FIGS. 22A-22B form a schematic flow chart showing a process for creating a new advertisement, according to embodiments of the present invention.

FIG. 23 is a schematic flow chart for creating a new advertisement using interactive voice response (IVR), according to embodiments of the present invention.

### DETAILED DESCRIPTION OF SPECIFIC EMBODIMENTS

In accordance with preferred embodiments of the present invention, methods and apparatus are disclosed for generating and causing display on a mobile communications device a geo-fenced advertisement.

### Local Offer Engine Overview

A Local Offer Engine provides a solution for location based advertising and marketing that is meant to be effective for advertisers, non-intrusive for publishers and fun and easy-to-use for end users. The local offers that are published with the system can be consumed within various applications by incorporating an ad-feed either through the use of a Local Offer Engine API or through incorporating a Local Offer Engine software development kit (SDK) for various mobile platforms. Advertisers can use either the Local Offer Engine web site or mobile web site to define their advertising campaigns or use an interactive voice response (IVR) system. The term IVR is meant as it is understood in the art. A user can provide information into an IVR system by speaking, by pressing touch-tone buttons on a telephone, etc., and is not limited to embodiments in which the human user speaks. There are various different types of geo-sensitive offers that can be incorporated within the campaigns ranging from simple text based offers, to graphical/display advertising offers, offers with redemption, virtual scratch-and-save offers, group buying offers and others.

The value of the offer engine for the publisher applications user base is in receiving a relevant, time-sensitive, and location aware discount that is actionable.

The value of the offer engine to publishers consists of having a shrink-wrapped, non-intrusive, location based advertising component within their application which monetizes with higher click-through rates and consequently higher revenue.

The value of the offer engine for advertisers consists of having a tool that can drive foot traffic of people interested in the product or service to the merchandizing locations. The engine allows access even to the smallest of advertisers that might not have internet access through the IVR component.

The offer engine platform SDKs are in effect embeddable location aware mini-applications with the purpose of optimize serving of relevant, location aware ads within applications.

Key Concept: Offer Visibility Radius Variables

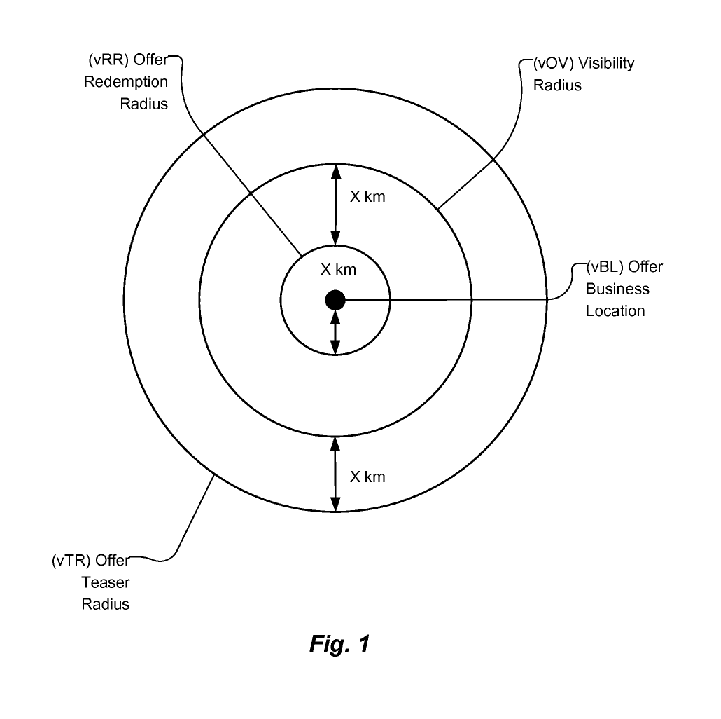

Given the complexity of geo-advertising, the SDK and server solution uses a geo-fencing concept made up of 3 tiers (note that for all fences we can also specify the altitude dimension which by default is set to all altitudes). These tiers are shown in FIG. 1, as will now be described.

vRR—Offer Redemption Radius, the distance from the business location(s) within which an offer that requires redemption can in fact be redeemed. This is validated by GPS, and unless the device is in fact within the specified radius, the offer cannot be redeemed. This radius does not apply to all ads, only those requiring redemption.

vOV—Offer Visibility Radius, the distance from the business location(s), not including the vRR, within which an offer can be viewed in full by a user. In this area users can see all the pertinent details for an offer, unless the offer is a scratch and save offer, for which the user only can “scratch” within the vRR.

vTR—Offer Teaser Radius, the distance from the business location(s), not including the vRR or vOV, within which an offer is “teased”—the user is given a glimpse of what the offer may entail, but is required to be within the vOV in order to actually see the offer details.

The term “geo-fenced” refers to the use of a tier system, such as the one just described, in which only certain elements of an advertisement, offer, etc., which are available at a particular geographic location, are not available at a different geographic location. The tier structure shown is merely exemplary; more or fewer tiers may be used, and the shapes of the tiers may be any appropriate 2-dimensional or 3-dimensional shape.

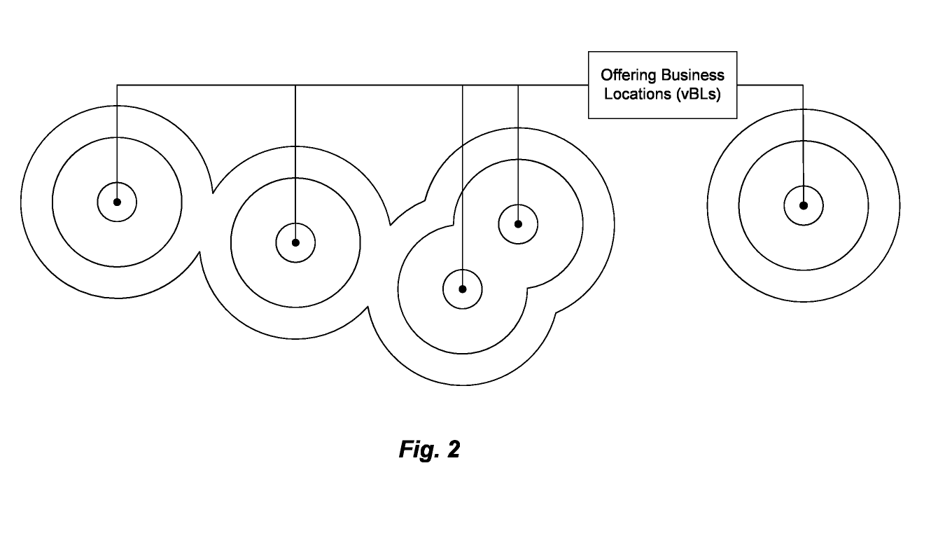

FIG. 2 shows an example in which each of five distinct offering-business locations (vBLs) has at least one active location-based offer.

### Offer Types

### 1. Text Offer

For a specific set of publishers (trusted publishers such as, for example, Poynt Corporation) an option of constructing the text offer within the application is provided. A text offer is constructed by a publisher based on an API request. The request specifies a keyword or category, user location and user preferences. In response, the system returns an offer that best matches the request. An exemplary API may include:

http://api.locoad.com/?lat=43.8&lng=79.8&range=1000&page

=1&rpp=10&keyword=italian&preferences=pizza,leisure
&did={device id}&appid={publisher app id}

In this request the lat & lng parameters specify the users location, (such as in terms of a latitude and a longitude), the range is the vOV (offer visibility radius, such as in meters), page is the page of results to be shown, rpp is the requests per page, keyword is a keyword associated with search or content, preferences are user preferences in terms of categories. The maximum product of page & requests per page may not exceed a predetermined value, such as ten (we do not want someone to just list all of the offers that we have in the system). The user preferences may include information that the publisher has in relation to users profile. For example, preferences could include a set of brands that the user has expressed interests in or a set of categories that the user has expressed interest in (opted in). The parameter appid is a mandatory parameter that identifies the publisher for the purposes of analytics and rate limits. In some embodiments, the lat, lng, range, page and appid may be mandatory parameters. In some embodiments, keyword and preferences are optional, but highly recommended, parameters, with keyword being more the important one of the two. In certain embodiments did (device id) is not a mandatory parameter but is desirable as it provides means of possibly matching preferences associated with the user of the device.

Based on the local offer engine ad matching logic, the best one or more ads are returned for publishers request (see matching logic). Here is an exemplary JSON output for the user's request:

| | |
|---|---|
| { | “offers” : [ { “address” : “55 Administration Rd, |

Vaughan, ON, Canada”,

“city” : “Vaughan”,
“clickthrough_url” : “http://locoad.com/offer/?id=12”,
“country” : “CA”,
“discount_percentage” : 0,
“distance” : 14.7382862381124,
“img_url” : “http://i.ehow.com/images/a04/a0/o6/cook-

healthy-spaghetti-meatballs-dinner-200X200.jpg”,

“merchant_id” : 14,
“merchant_lat” : 43.802631099999999,
“merchant_lng” : −79.504492900000002,
“merchant_name” : “unopizza”,
“offer_end” : “/Date(1280635200000-0400)/”,
“offer_id” : 64,
“offer_start” : “/Date(1277956800000-0400)/”,
“offer_text” : “unopizza 5 Spaghettis for $4,488.00

valid until Aug/1/2010 12:00 AM”,

| | |
|---|---|
| | “phone” : 4165433324, |
| | “postal” : “L4K”, |
| | “price” : 4488.0, |
| | “product” : “Spaghetti”, |
| | “quantity” : 5, |
| | “redemption_code” : “”, |
| | “source” : “1-800”, |
| | “state” : “ON” |
| } | ] } |

The parameter “source” value of “1-800” indicates that the offer was created using a toll-free telephone number.

The offer preferably is displayed clearly as an advertisement within the application. The publisher preferably may not change any of the text of the offer. In addition the publisher preferably implements at least the click-through action which opens up in a web browser on the mobile device. It is also recommended that the publisher implements click-to-call action. Note that if the advertiser's email address is provided during the merchant registration, the address would also show up in the response, in which case the publisher might opt to implement a click-to-mail action. Note that the publisher also preferably implements an appropriate analytics call associated with the offer lifetime events (see Analytics API section).

The clickthrough_URL may include a URL on the local offer engine servers. The advertisers can control the behavior of the clickthrough_URL when creating the offers. By default, invoking the clickthrough URL will cause rendition of a coupon-like output with a map by the local offers engine servers. The advertiser can instead choose to have the clickthrough_URL redirect to a specific URL. Preferably, the clickthrough URL goes first through the local offer engine server, so that the appropriate analytical API click-through event is registered against the offer.

### 2. SMS Offer

SMS Offer is a specific version of the text offer where the text is delivered through a short message service (SMS) message to the user's phone in response to an action by the user. For example, the user may be alerted, through some medium, to the required actions to receive the offer. For example, the user might see an ad in print media, or a billboard, or a web page, or hear and ad on radio where the ad conveys a message, such as: text in your query and location to 769868 to receive an offer. Optionally or alternatively, the user may sua sponte requests for a search offer.

In either case, the process starts with the user sending an SMS inquiry to the ad engine's SMS gateway. Since the SMS message header does not contain the user's location, the location preferably is encoded by the user as part of the message body. An exemplary SMS inquiry sent to an ad-engine short code (76968) may contain:

coffee 5400 yonge Toronto

The example query thus is searching for entries matching “coffee” in the area of address “5400 yonge [street]” in Toronto. Our SMS gateway receives the SMS message, and the message is parsed for any commands (list, next page, more, etc.) as well as the nature of the query (category) and location. The location is geo-coded, and the information is passed to the ad engine for matching. The top matching offer is sent back to the user in an SMS, such as:

** Starbucks, 5650 Yonge St, 200m North, 18776976969

http://locoad.com/igb54W085z0

The SMS reply indicates that coffee is available at Starbucks, located at 5650 Yonge St, which is 200 m North of 5400 Yonge St, and a telephone number is provided for contacting the Starbucks. Note that the text of the SMS message is prepended with “**” to indicate that the message in an advertisement (in accordance with Mobile Marketing Association (MMA) guidelines). Also note in this example that the phone number sent to the user preferably is not the actual Starbucks phone number. Instead, it is a phone number that belongs to the offer engine that will, upon user's call, lookup the recent query from the user and redirect the call to the actual Starbucks number. This allows the ad-engine to track the call-to-call events for billing and reporting purposes. Similarly, the URL (for phones that do have a browser and data plan) allows us to track the click-to-web actions from the SMS messages.

An alternative implementation allows other developers that use SMS as means of communication to connect to the ad-server through an API to receive the local offers and send them to the users through their SMS gateways. An example of this is a service such as Email2SMS.

### 3. Display/Banner Offer

The publisher can request banners in one of the standard MMA sizes (4:1 and 6:1 aspect ratios). Standard 4:1 sizes in pixels are: 300×75, 216×54, 168×42 and 120×30. Standard 6:1 sizes are: 300×50, 216×36, 168×28, 120×20. An API request for a display/banner offer returns a url to the universally accessible image URL, associated click-through URL and associated text tagline ad. On phones that cannot render images, the publishers should render the text tagline ad as a hyperlink with the destination being the click-through URL.

Here is a sample request:

http://api.locoad.com/?&type=banner&size=300x75&lat=43.8

&lng=79.8&keyword=italian&preferences=pizza,leisure
&did={device id}&appid={publisher app id}

And here is the sample JSON response:

{“clickthrough_url” :

“http://locoad.com/offer/?id=QuEfGbj9qS4”,
“img_url” :
“http://img.locoad/?id=QuEfGbj9qS4&size=300x75”,
“offer_text” : “unopizza 5 Spaghettis for $4,488.00
valid until Aug/1/2010 12:00 AM”

The img_url parameter points to a URL on our MMA-compliant image generation server. The image server renders an image based on offer parameters and text of the offer as well as any associated campaign theme. In a case where the offer has a specific image (e.g., a picture of a slice of pizza) such an image will be used in rendering the banner. Otherwise, standard stock images associated with the category of the offer's content will be used. The location of the image, the size of the image and the location, and the font-face and size of the text can be determined from the campaign theme. Internally, the image server also performs the required analytical API calls (the display event). The clickthrough_URL is an address of a local offer engine, which can render a coupon within the page with a map.

On all other phones, the publishers can embed a standard platform-specific SDK that will do the rendering within our ad component. The publisher can request a refresh from the ad component by invoking the refresh function. Here is a sample refresh new ad request for an embedded component:

final LocoadView ad=(LocoadView)
findViewById(R.id.ad);

ad.lat=43.8;

ad.lng=−79.8;

ad.keywords=“italian”;

ad.preferences=“pizza,leisure”;

ad.deviceId=“{device id}”;

ad.appId=“{application id}”;

ad.requestFreshAd( );

All of the parameters in the requestFreshAd invocation are optional in this example. If the application does not provide the latitude and longitude, the ad component attempts to resolve location using the platform-specific geo-location toolset. This implies that any application that will be incorporating the local offer engine ad component will have to have request geo-location privileges. The publishers can avoid unnecessary location resolution requests from the ad-component by providing the latitude and longitude parameters. This is important, because the publisher could have a better sense than the advertising component as to the possibility that the device position has changed, and unnecessary location requests can influence device battery life.

Internally, the platform SDK ad component performs an API request. The image to be displayed within the banner is generated by the image server based on the img URL. The ad component renders the image on the device. In addition, the ad component also enables, by default, the following actions through a context sensitive menu:

1. Click-to-call: makes a phone call to the phone number specified in the offer.

2. Click-to-map: displays the location of the offer within the native map display.

3. Click-to-mail: for offers that have an associated email address, invokes the email intent with specified email address. (The term “intent” here is an Android operating system term used to signal the operating system to find an application that conforms with the desired action. There may be more than one application that can handle the intent of sending an e-mail message, in which case the user is prompted to select one of the applications.)

4. Click-to-web: opens the clickthrough_URL in the web browser.

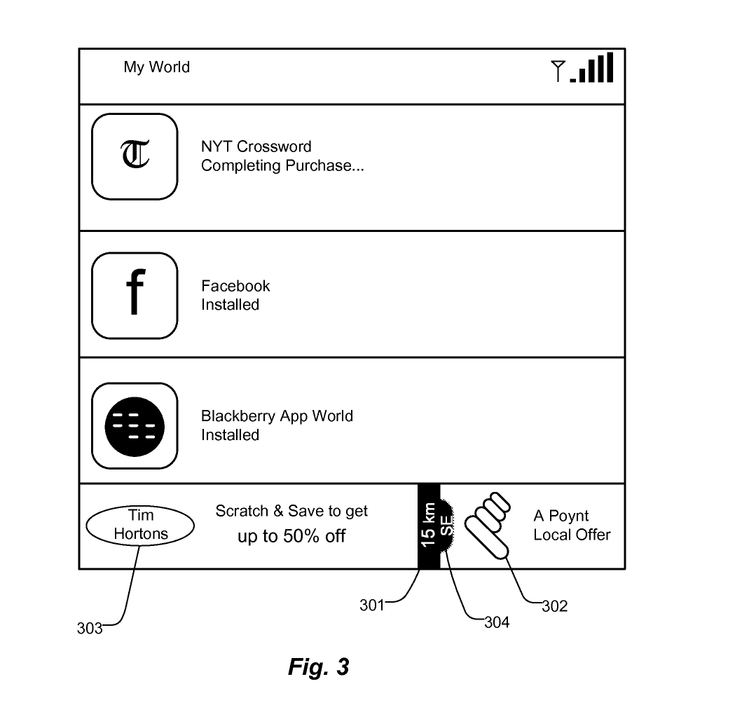

Since we have the user's location (either through the app passing it in or through the component resolving it), the ad engine can generate banner ads that include location-specific information, such as distance and direction. For example if the user is some distance away, the ad may look like the example shown in FIG. 3.

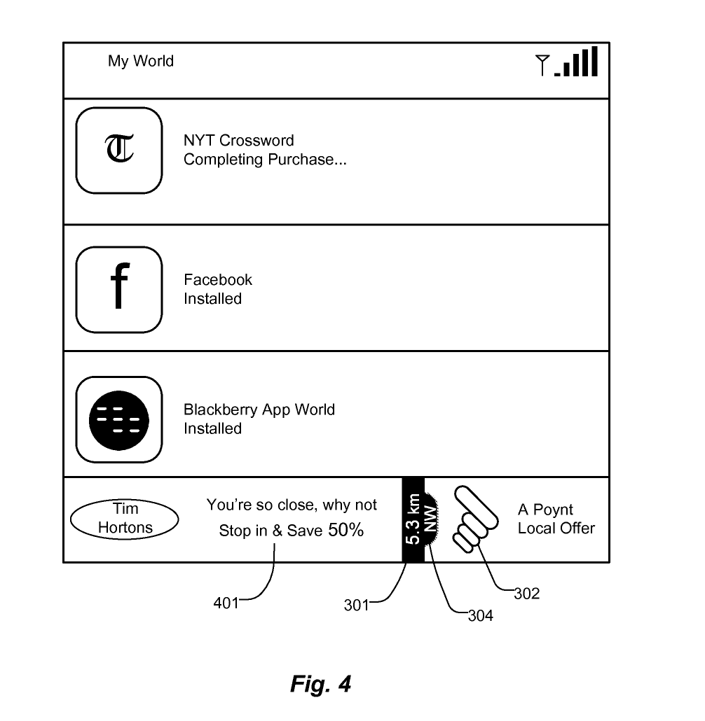

A distance band 301 indicates the distance to the offering-business location (vBL). The distance band 301 may be color-coded to provide a quick visual indication of how far it is to the vBL. Since this example is for when a user is far away, it would preferably be blue. The direction to the vBL is shown as SE on a mini-tab 304 of the distance band 301, as well as by a logo 302. A teaser 303 for the offer shows that the vBL is a Tim Horton's store and that the offer is a scratch and save offer with a maximum discount of 50%. As the user travels further, the next time the user gets an update the ad may reflect that the user is closer, as shown in FIG. 4.

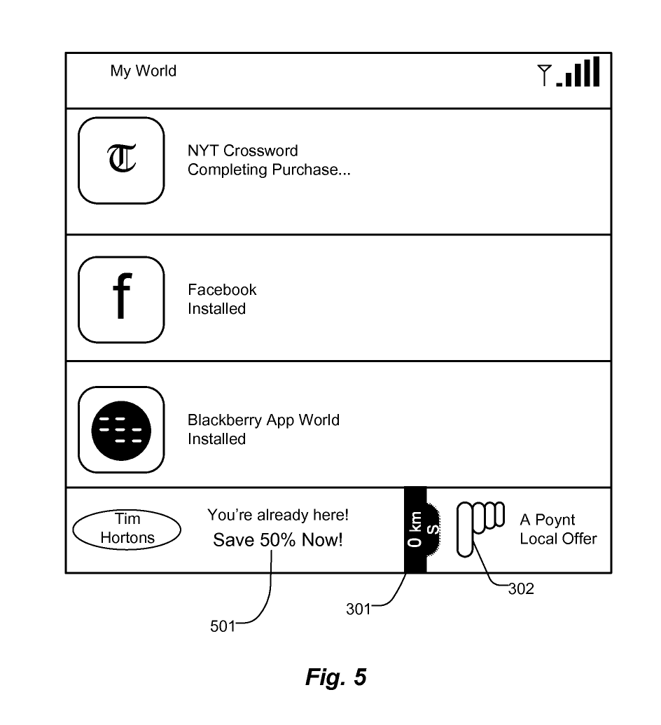

Now the band 301 may be green to reflect that the distance is smaller. The ad 401 now reflects that the vBL is close by. The banner is dynamically generated by the server. Distance and direction are rendered by the ad engine image server. The whole image is dynamic, since the background color, brand and text are also rendered dynamically based on what the advertisers have specified in their campaigns. When the user is in the immediate vicinity of the business location, the ad could look like FIG. 5.

In FIG. 5, we see that the user has arrived at the vBL. The location band now may be red to reflect that the user is at the location associated with the offer. The color scheme just described includes the following settings: far: blue/cold; closer: green; at location: red/hot. The ad 501 also has been updated to reflect that the offer is now active, and the user may activate and use the scratch and save offer, as will be discussed in detail below.

### 4. Display Offer with Geo-Fenced Redemption

The display offer with geo-fenced redemption is implemented by serving a teaser ad, which is a Display/Banner offer (see previous section) with the intention of bringing the user to the merchant's location. In order to receive the benefit of the offer, the redemption ad requires the user to open up the ad within the merchant's location in order to activate the redemption. The redemption may, but need not, be related to automatically reducing the price at a point of sale (POS) system. For example, small merchants' POS systems may be integrate with large merchants through IBM or another integrator. The primary purpose of the redemption is to ensure proper analytics and therefore show the return on investment associated with the location-based advertising campaign. The user is shown the teaser ad within the standard location offer engine component. The user can perform the standard click-to-call and click-to-map actions, but when the user performs the click-to-browse action, the URL that he is directed to is the URL for a redemption offer. In order to save on GPS requests, the publisher should pass the lat/lng of the user as additional parameters to the URL. If such parameters are not passed, the HTML5 app can attempt to geo-locate the user using a standard HTML5 JS geo-location API. The redemption offer shows the offer as a locked offer if the offer is outside of the vRR, and it indicates that the user needs to get to the merchant's location to unlock it. A button for unlocking the offer is present, but clicking on it triggers a geo-location resolve, and clicking on it outside of the vRR just indicates to the user that he needs to go to the merchant's location. The user can save the location as a bookmark within the browser. Once the user arrives at the merchant location, he brings up the saved URL from the bookmark, and he can click on the unlock button, which now unlocks the offer and triggers the corresponding analytics redemption call offer. The merchant should honor only unlocked offers.

### 5. Scratch-and-Save

The concept behind the scratch-and-save offer is that it mimics the real-world scratch-card concept. The scratch-and-save offers do not reveal to the user the actual amount that can be saved until the user is at the actual merchant's location. According to some embodiments, the offer can be revealed by scratching the virtual scratchcard only when the mobile communications device is within the immediate vicinity of a business. The term “immediate vicinity” is meant to include locations that are both within the actual location of the business and locations that are within a predefined distance from the business, which is less than a distance at which the advertisement is meant to encourage the user to go to the business, such that when the user is within the predefined distance, the user has essentially arrived at the business. Once at the location, the recipient of the offer can shop, bring his merchandise to the counter, show the offer to the cashier, “rub” the screen to “scratch” the cover that is hiding the actual offer value and then redeem the offer by presenting the revealed offer to the cashier. The offer can be specific to all the locations in a franchise or it can be specific to a single location or selected locations. Revealing the offer value may be performed in various embodiments according to any appropriate virtual scratching function, including rubbing the screen with a finger or a stylus, moving the cursor with an input device, such as a trackball or arrow keys, or simply by clicking or typing into an input field, such as a “reveal offer” button, which may trigger, e.g., an animation sequence of the virtual scratchcard being scratched. Embodiments of the present invention also include functions that reveal the entire offer immediately when triggered, without such an animation sequence.

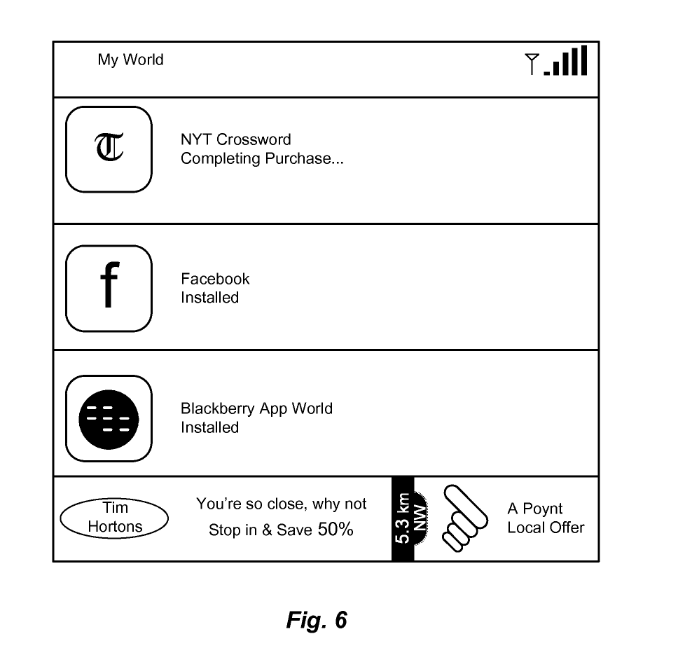

The process starts by a user performing some action within one of the publisher applications that incorporate the local offer engine ad component. Given a match on the parameters passed to the requestFreshAd call (scratch & save may have a higher cost-per-click (CPC) than other offers, so they will be given higher weight in the matching process), a user is presented with a teaser ad within the vTR (offer teaser radius). The teaser ad fits within the standard MMA size for a display ad, and it conveys to the user the fact that there is an offer available at one or more locations nearby. Such a teaser ad is shown in an example in FIG. 6.

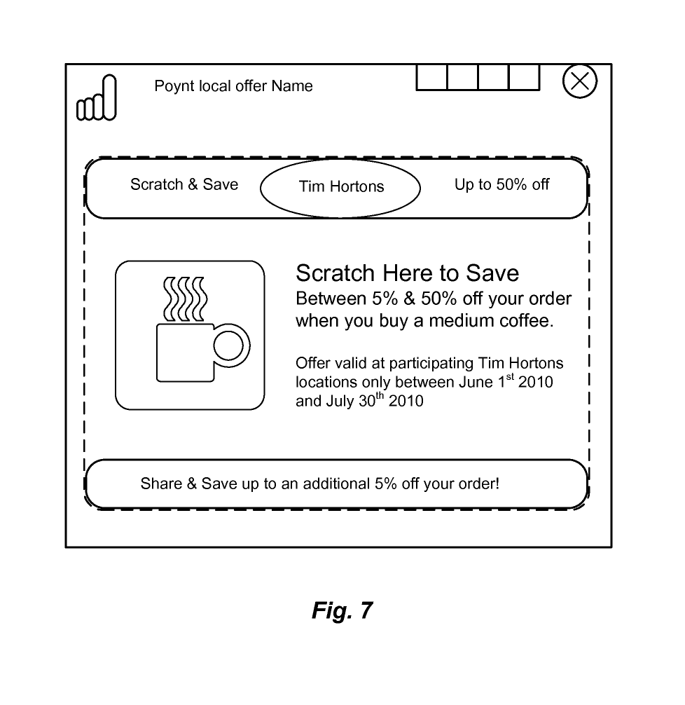

When the user clicks on the teaser ad, he receives an enlarged, overlay version of the ad that reveals further details. An example of a teaser scratch-and-save ad for Tim Hortons displayed within an application such as Poynt is given in FIG. 7. In this example, the screen size is formatted for a BlackBerry Bold style device.

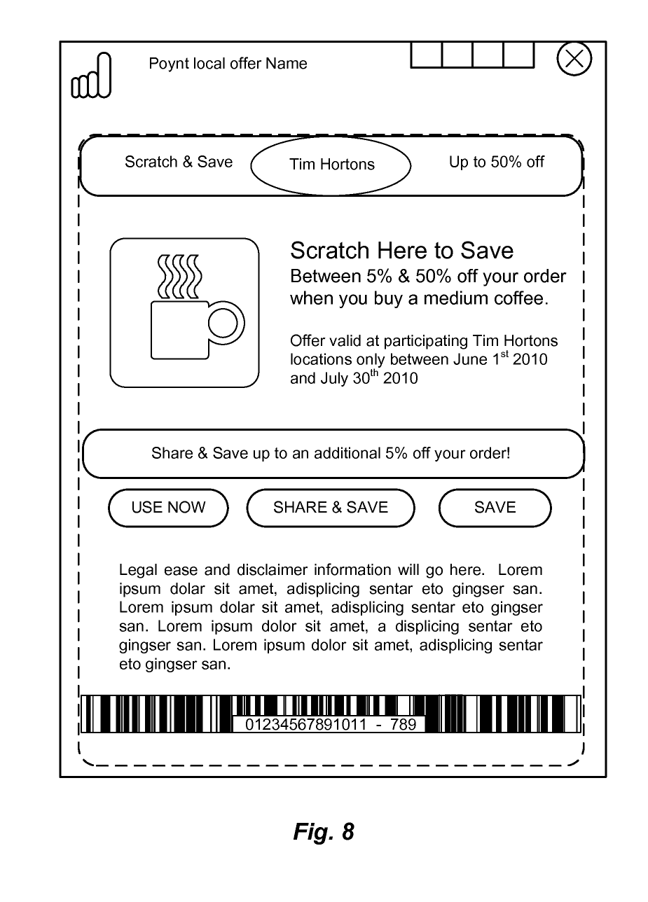

A further example of a teaser scratch-and-save ad is shown in FIG. 8. The user can see that the offer is up to 50% off. The user also can see that the brand that is shown in the offer is Tim Hortons. In addition there is a top bar that is meant to display readily accessible actions (such as alerts, click-to-call, click-to-browse, click-to-map). These action icons are displayed based on the “don't make me think” principle, according to which it is better to know actions that can be taken in advance than to have to click to see the details.

The “Use Now” button is meant to activate the scratch mode. Clicking on this button while outside of the vRR (offer redemption radius) preferably will bring up an alert dialog informing the user that he needs to perform this action in front of a cashier at the offer location. The alert dialogue it might also display a map to the closest location where the offer can be redeemed. The “Share & Save” button activates the sharing flow, which enables the user to save an additional (for example) 5% by sharing the fact that he redeemed the offer at a particular location within his social network, such as Facebook or Twitter. This may be granted in return for the user posting on a social media web site a message, such as, “I just saved 50% at Tim Hortons on Bathurst & Steeles,” along with a hyperlink to the merchant's web site and/or a hyperlink to some other action that allows another user to receive a similar type of offer. An exemplary flow sequence is discussed below. The “Save” button allows the user to save the offer and dismiss the screen. When the user comes to within the vRR redemption area, the offer will automatically be activated and the user can then decide to use the offer or dismiss it via the x in the top right corner. The bar code displayed on the offer is provided by the merchant in a batch feed to a local offer engine as a sequence of numbers and associated discounts. Each offer is associated with one such number that uniquely identifies the discount. The bar code can be scanned at the merchant's location, so that the discount can be applied automatically at the point of sale.

Once the user comes within the vRR, the saved scratch-and-save offer is brought to the screen automatically. In some embodiments, an application, such as a local offer vault, is provided for bringing up the saved offer on demand. The application may have a push notification and may activate a display similar to the top-level navigation within the compositions (such as images or figures). Alternatively, as discussed in the app vs HTML5 section, all of this may be implemented as an HTML5 web app. The user can then save the bookmark and call up the bookmark at the store. It is also possible to have only one URL (for example, a URL of the local ad engine, such as http://locoad.com) that the user visits by saving his login credentials through cookies/local storage within the browser on clicking the save button. Then, upon visiting the local ad engine (ex., http://locoad.com), the user may be automatically logged in and shown his saved offers. When the offer is retrieved, preferably by one of these techniques, the offer is activated.

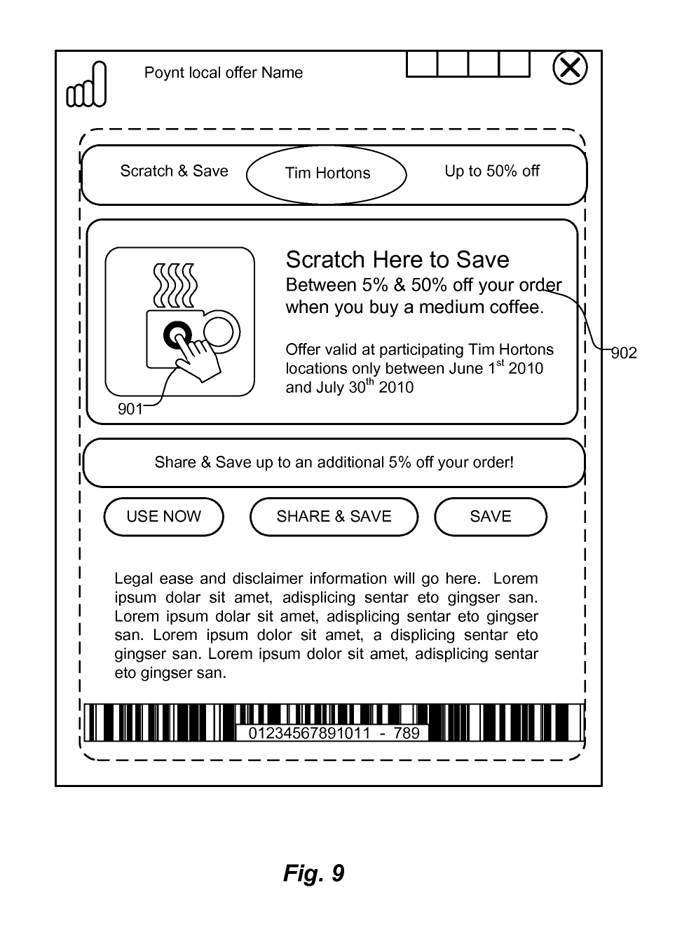

The activated offer displays a virtual button and a hand hovering over the button, to indicate a starting point of a scratch-and-save action. On touchscreen-enabled devices, the user can simply click on the button and start moving his fingers to mimic the real-world scratching gesture. On BlackBerry Bold style devices, the focus is placed on a dot, and the user moves a trackball to scratch off the cover. An example of an offer which is being viewed by a user using such a device is shown in FIG. 9. The virtual hand 901 is positioned over the scratch area 902 in preparation for scratching the virtual scratchcard to reveal the offer.

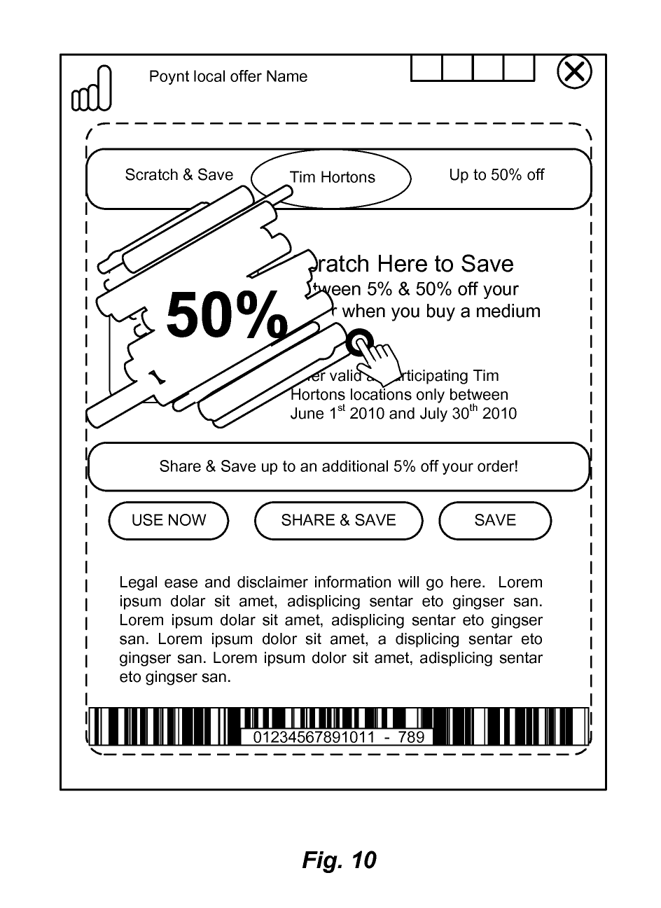

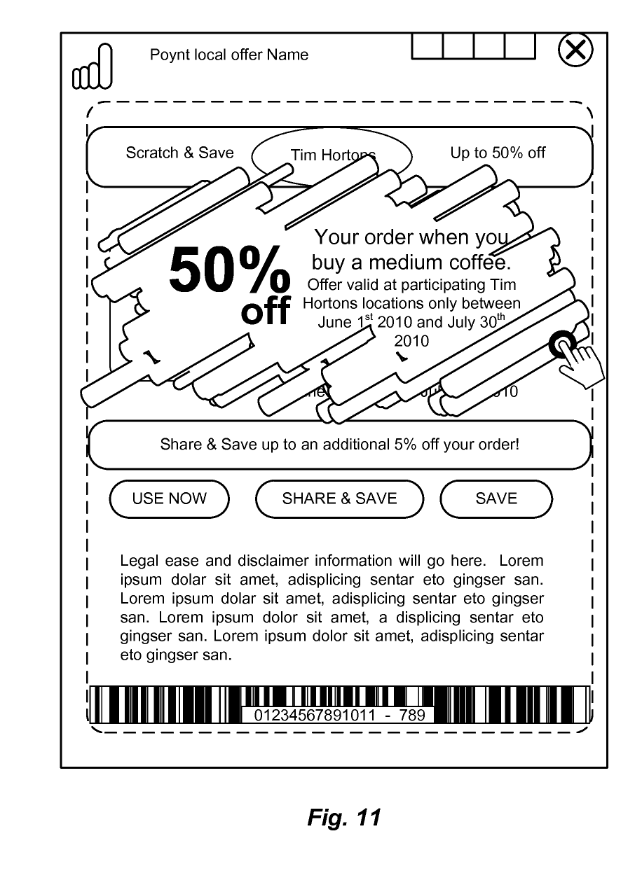

As mentioned previously, each scratchcard has an associated discount amount that was passed in from the merchant. This amount is looked up during the internal API call from the ad component to the backend. The beginning of the scratch process in an exemplary embodiment is shown in FIG. 10. The end result of performing the scratch-and-save action is shown in FIG. 11.

Once the scratchcard has been scratched to reveal the offer, a cashier can scan the bar-code at the bottom of the scratchcard and a point of sale (POS) system can automatically apply the discount that is associated with the serial number encoded within the bar-code. The code can also be displayed as a QR code, if the merchant's POS system has the ability to scan QR codes. An example of a QR code is provided in FIG. 12.

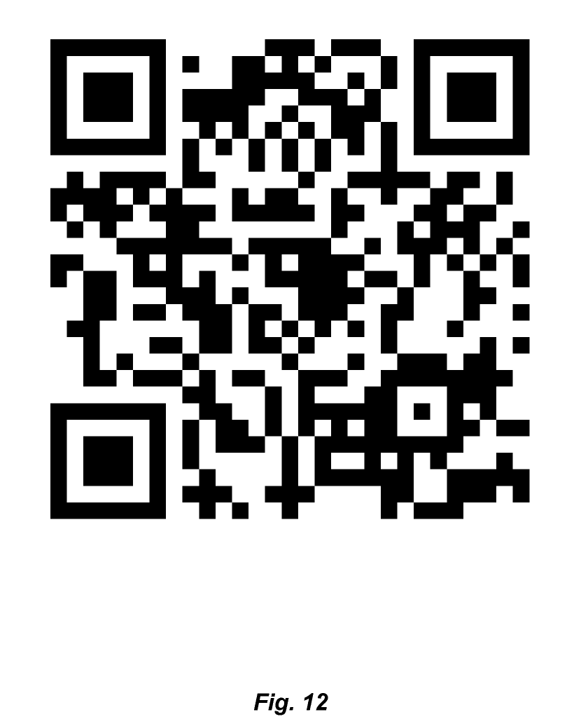

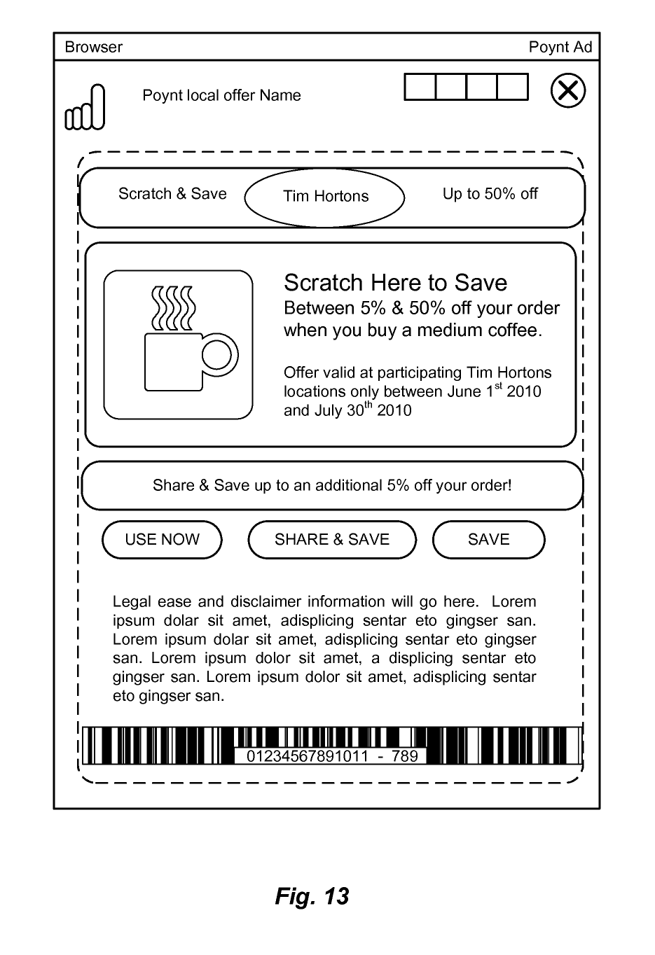

The screenshots above were shown as a possible implementation by the publisher of the in-app offer vault. An example of an offer displayed in the browser, once recalled from a saved URL, is shown in FIG. 13.

### Group Buying

Group buying may be implemented as a location based offer. An advertiser may specify the required number of buy-ins (participants) for the offer to be valid. In order for the group buying to work, the users would need to be able to buy into the offer right within the advertising. When the required number of participants is reached, all of the bought offers are honored.

### Billing

Preferred methods of billing for offers include:

1. Fixed Cost—fixed recurring cost (e.g. monthly), which provides advertisers the ability to place a certain number of offers per month with a limit on number of views/actions.

2. Variable Cost/CPM—cost per 1000 impressions.

3. Variable Cost/CPA—cost per action. Different costs can be associated with different actions.

For the Variable Cost mode it is possible to have either the price set in advance or to have the market set the price by providing an auction system. In either case, the real-time reporting of the user actions needs to be an input into the matching engine so that we know what advertising supply is available, based on cost and budgets.

As noted, the offer engine simplifies the advertising process for merchants. Fixed cost billing provides the simplest method of billing. One of the questions that arises from the fixed cost model is how to share revenue with publishers and mediation networks, where the model is based on performance. One possibility is to essentially treat the fixed cost as a budget and set the CPM/CPC/CPA rates such that the budget is used optimally but not exceeded. In order for this method to work, real-time reporting of user actions should provide a feedback loop into the billing service. The offer engine can be sold to the merchants through a sales organization (e.g., ReachLocal, Yellow Pages, Super Pages and such). Since these organizations have an established rate card and relationship with the merchant, the whole collection process can be simplified by having the sales partner submit an aggregate payment for the merchants on the monthly basis. This also means that these organizations will need to be able to inform us if non-payment and termination of an account are required.

### Offer Matching Engine

The matching engine takes an incoming request with various details and attempts to find the optimal ad. The following is an exemplary list of input parameters:

1. Location—latitude, longitude, altitude

2. Velocity Vector—speed and direction of travel

3. Query—any query that the user is performing, if a search application

4. Category—category of ads (e.g., fast food restaurants, movies, sports)

5. User preferences—categories of ads or brands that the user expressed an interest in

6. Text Context—in cases where the application serves ads within the context of some text, the text of the page

7. Device Type—the type of device

8. Display Size—the size of the ad display

9. Unique User Identifier—an identifier for the user

10. Device Identifier—an identifier for the device

11. Offer Type—used to request specific type of offer, such as: any, display, redemption, scratchcard

12. Paging—page, request per page

Based on the input parameters the offer matching engine finds an optimal ad in terms of a combined score based on:

1. Relevance—each offer has associated offerers' keywords and categories

2. Location—taking into account offerers' geo-fenced areas

3. Revenue (CPMs, CPC)

The offer matching engine may be implemented using a combination of geo-filtering to get an initial set of applicable offers and a score (a weighted score based on the relevance factors and the revenue) may be applied over the geo-filtered set to get the best match.

### Merchant Sign-Up Process

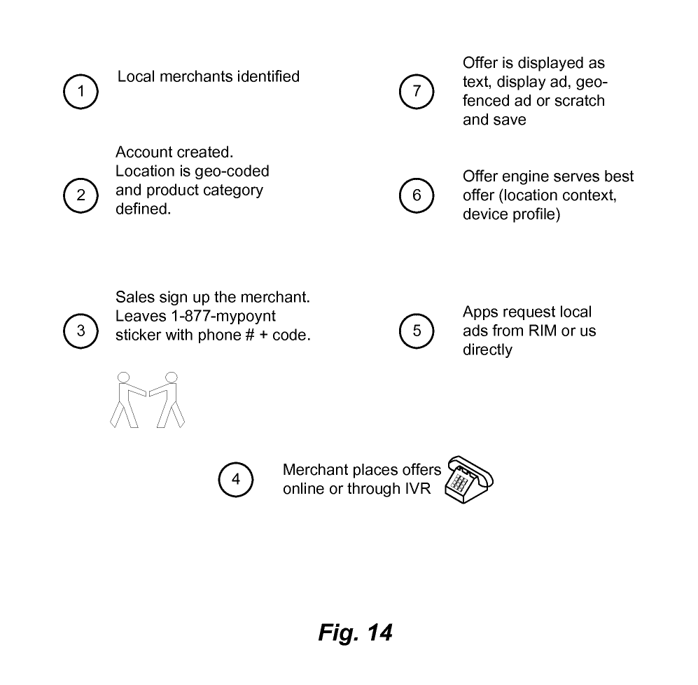

There are two preferred ways for a merchant to become an advertiser within the local offer engine system. The merchant can sign up by going to the web site and filling in the sign-up form, or the merchant can be signed up through an affiliate/sales-person who fills out the required information on behalf of the merchant. An “assisted” sales process is illustrated in FIG. 14.

### Merchant Self-Register

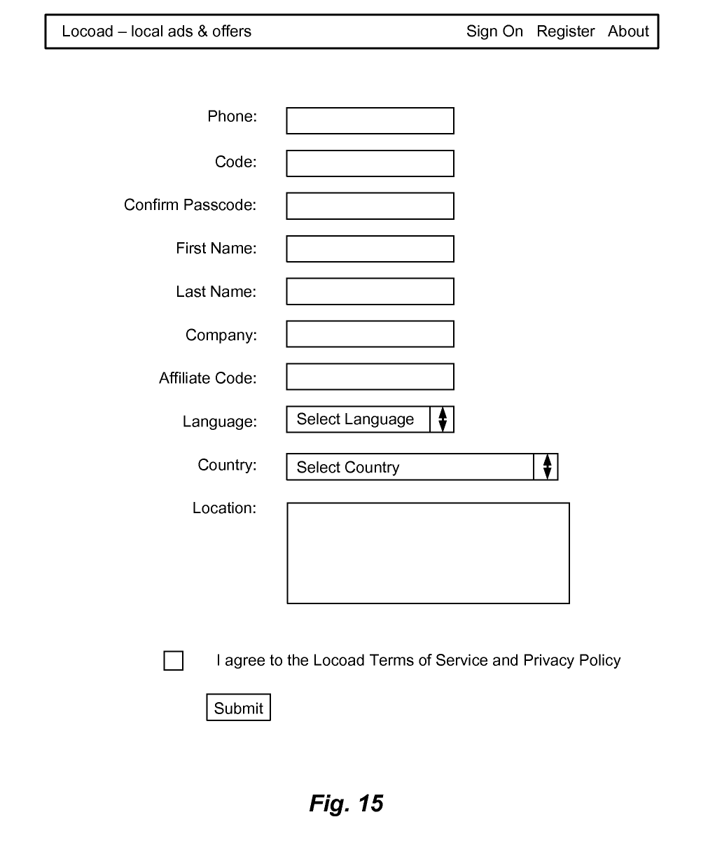

The merchant can sign up on the web site by filling in a form, such as the form shown in FIG. 15. The user id and password are preferably phone number oriented to streamline the potential use of the IVR process.

A valid address should be provided in the address field, because this address will be geo-coded and the associated lat/lng will be used for forming the offer visibility radius.

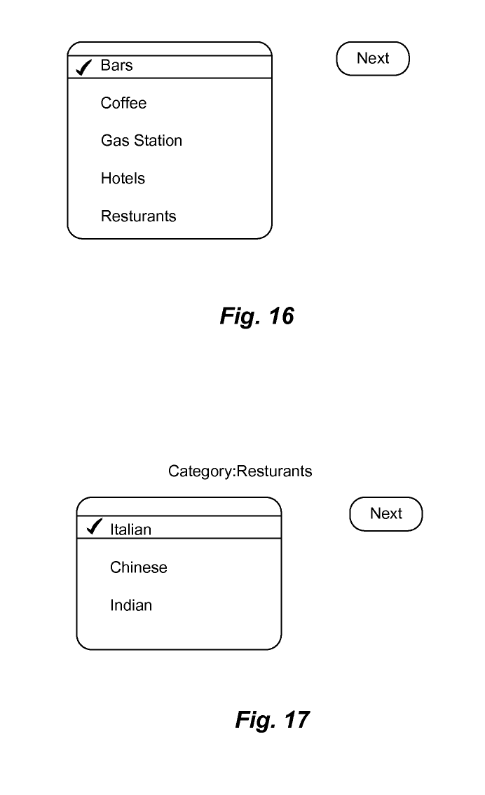

In another menu, the merchant selects a business category. Selecting a category determines the types of products for which the merchant can create a structured offer using the IVR. If the merchant is using the online web site to create offers, he does not have to follow the structured offer and can enter any text that he wishes for the offer to work. An exemplary input menu for specifying the business category is shown in FIG. 16.

In another menu, the merchant can specify the sub-category for the business. For example, for restaurants, the sub-categories may be as shown in FIG. 17, namely “Italian,” “Chinese,” or “Indian.”

Selecting a sub-category sets the types of products for which the merchant can create offers. Once the sub-category is selected, the merchant can then use the IVR to place offers for products that are in the mentioned category. Note that the merchant can create offers for any category/sub-category/product that he wishes when using the online site, and if there is no such product, he can define the offer through free-form text. That is, in some embodiments, there are no restrictions on the type of offer that the merchant can create using the web site. However, in some embodiments, the merchant uses a sub-category associated with the merchant account in order to provide a limited set of products from which the merchant can select using the IVR number system to place an offer.

The same system can be used by the sales force to sign up the merchant ahead of visiting them. When signing up a merchant prior to visiting the merchant, the sales force should populate the affiliate field to associate the merchant with his account. The sales person can leave the phone number for IVR call-in and the user credentials (phone number and pass code) with the merchant so that the merchant can place new offers immediately.

### Merchant Basic Information Architecture

Once logged in, a merchant/advertiser/brand manager will have a simple user interface through which he can manage his ongoing advertising relationship with the Local Offer Engine system. Use of this functionality is optional and supplemental to the simple ad set up process that mimics the IVR system.

With this management console, users can manage their ads and campaigns, and they can review and track statistics and metrics on individual ads or on entire campaigns. Users also have the option to provide detailed information about their businesses that will help in delivering ads to appropriate audience segments by allowing merchants to provide information (through the use of checkboxes or free-form tags) on which markets they target and details about the individuals they most want to reach.

Furthermore, the console allows users to:

1. Upload reusable brand elements, such as logos and images, that can then be used by any or all of their future ads.

2. Add and manage business locations (single or franchises).

3. Add and manage location groups (collections of locations that are related regardless of geography) and regions (collections of locations associated by a geographical area). Groups and/or regions can be used to determine which locations are to participate in a coupon or offer.

4. Add secondary accounts that are able to access and use the management console, in whole or in part based on user-specified privileges. This could be used for data collection staff or for a regional manager that controls the offers and metrics for a given geographical area.

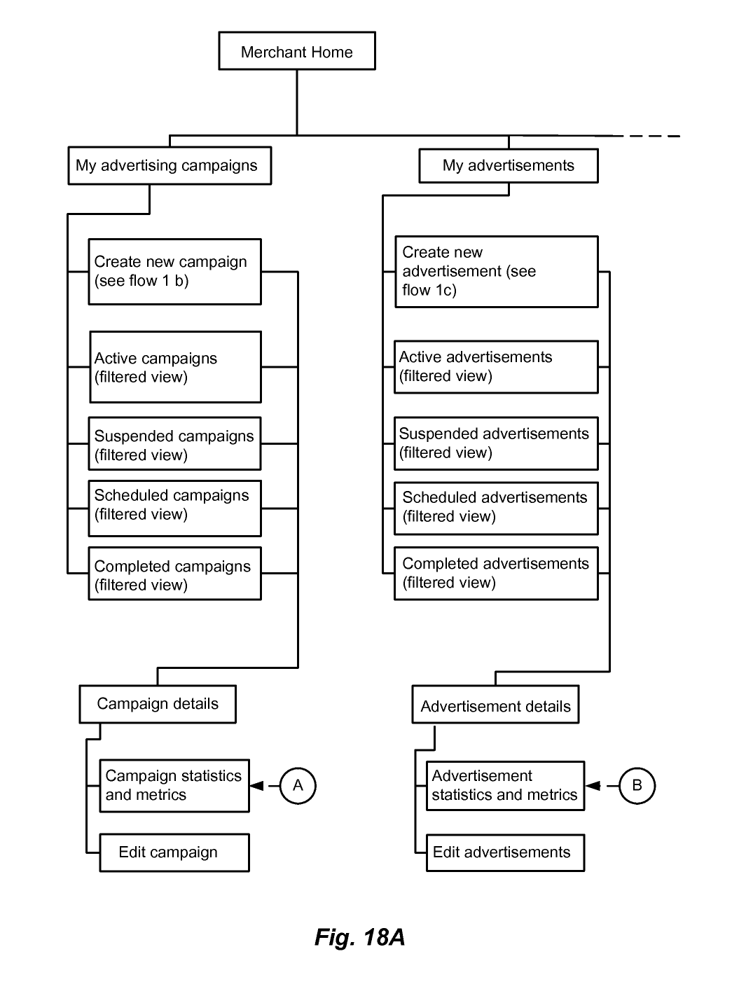

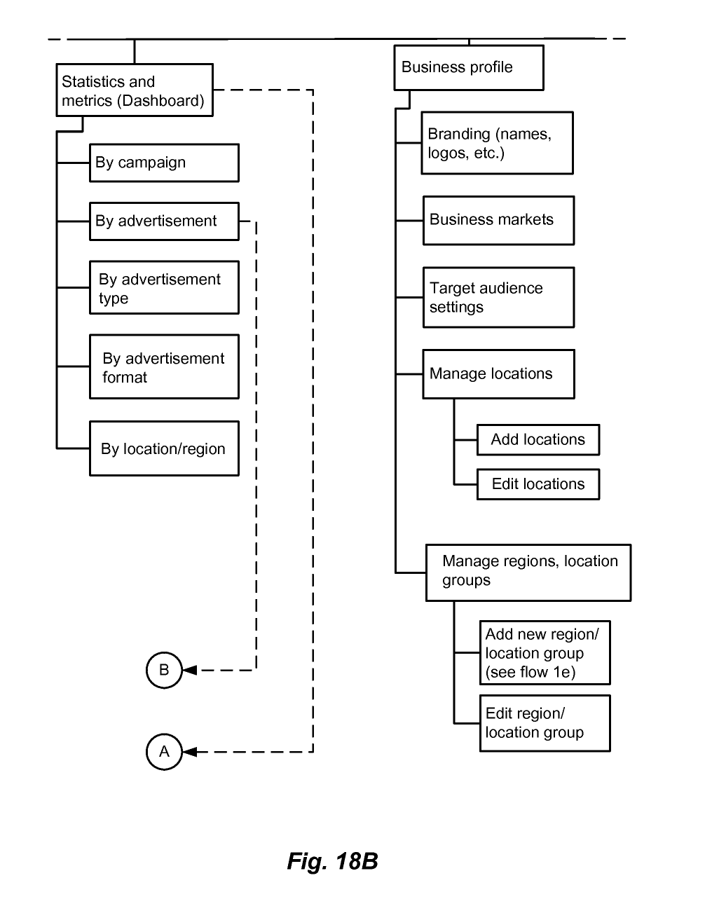

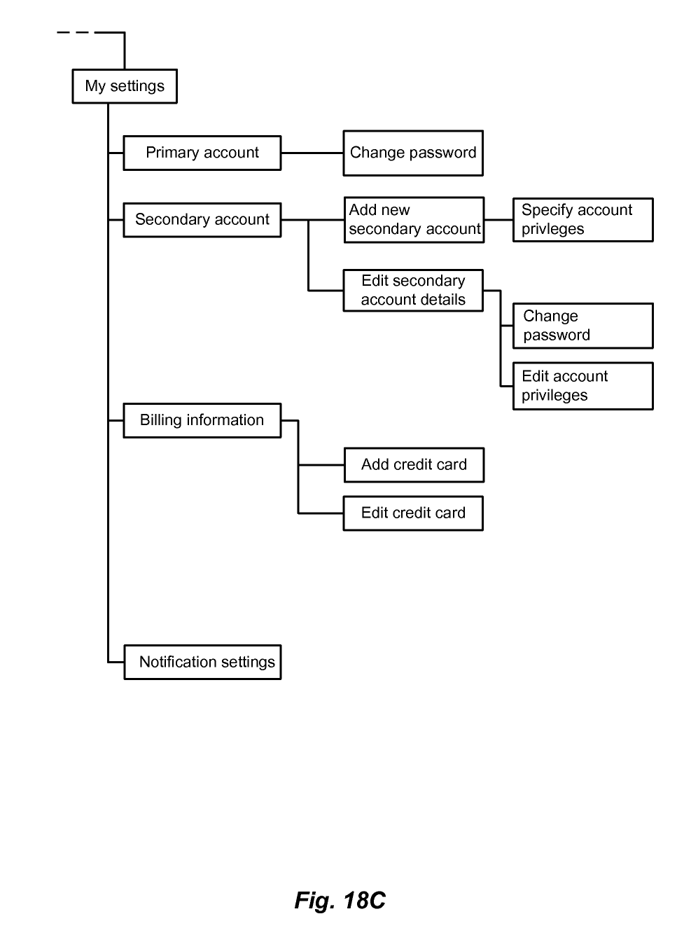

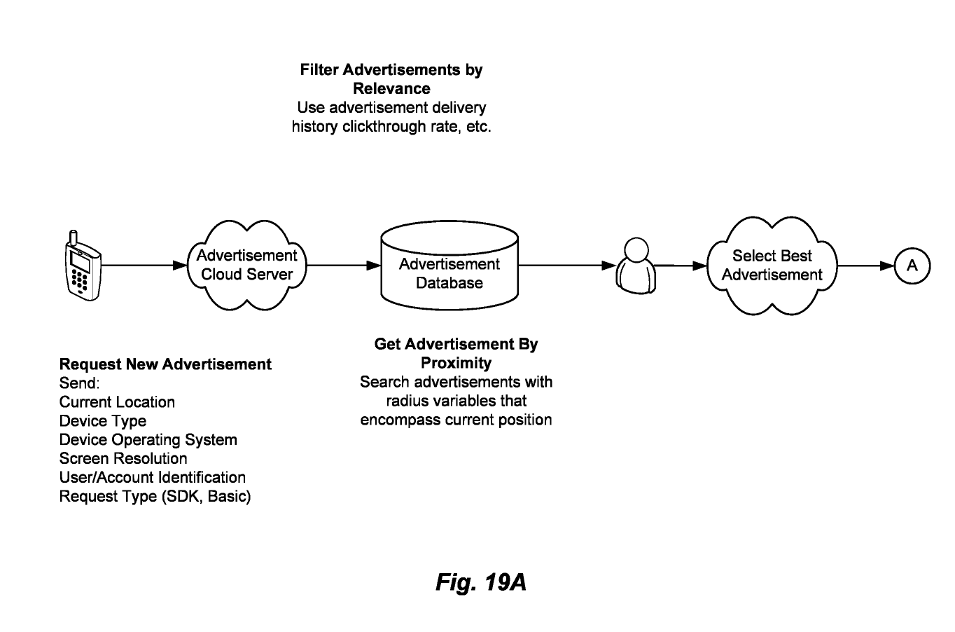

Further details of options that the console may provide to users are given in FIGS. 18A-18E.

### Ad Request From Device

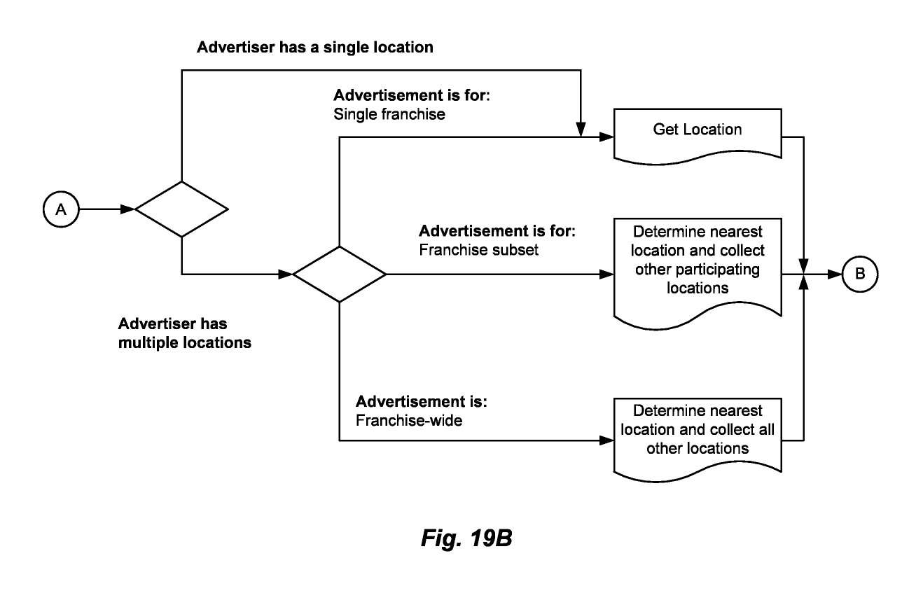

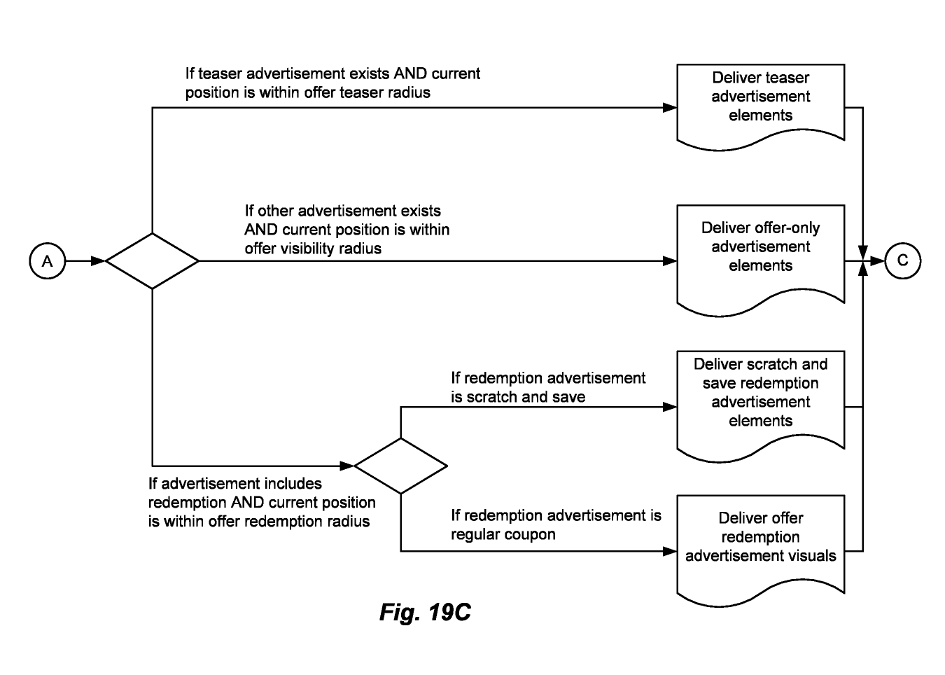

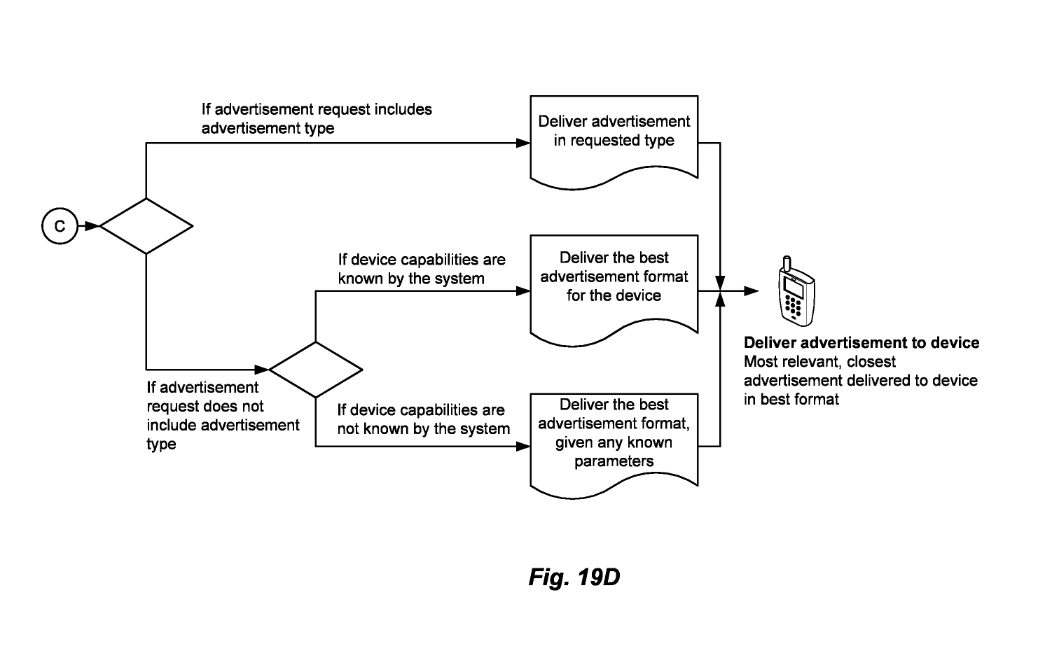

Process flows defining exemplary processes for determining which ads are served, when and why upon request by a device are provided in FIGS. 19A-19D.

### Ad Display on Device

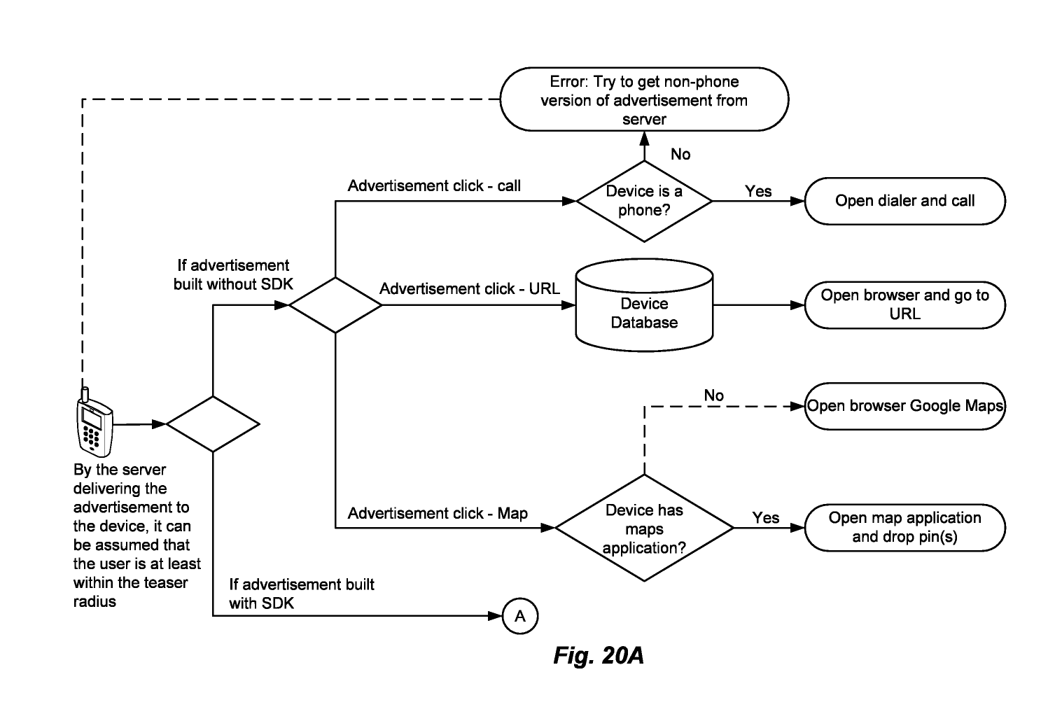

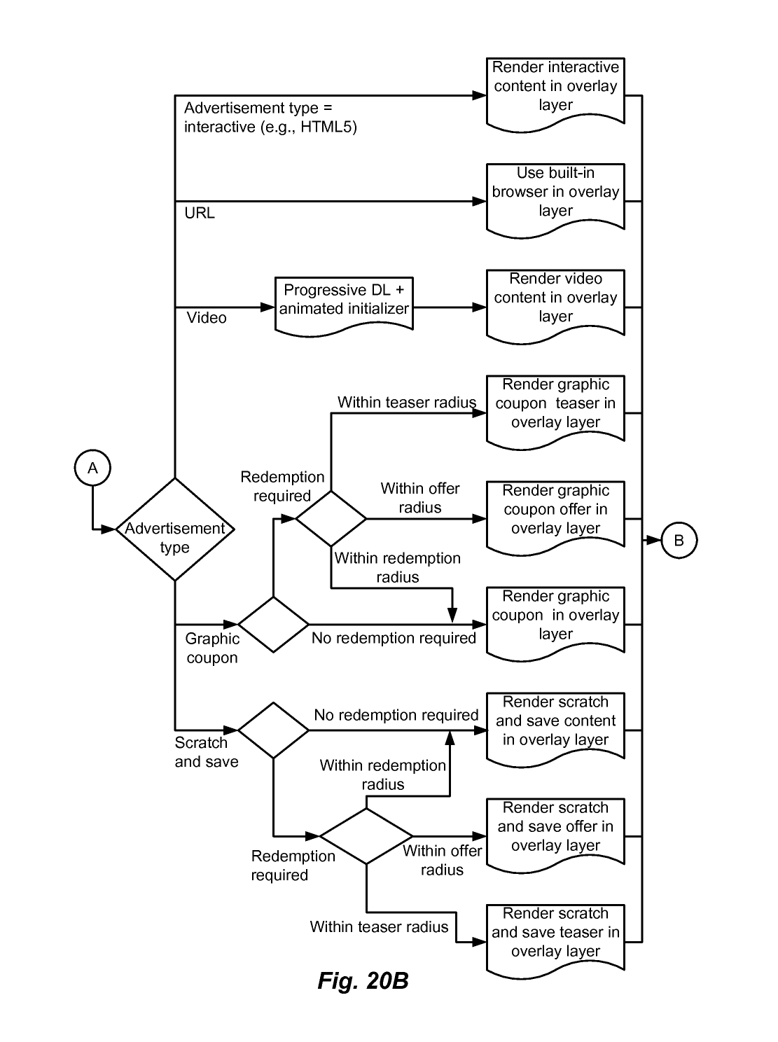

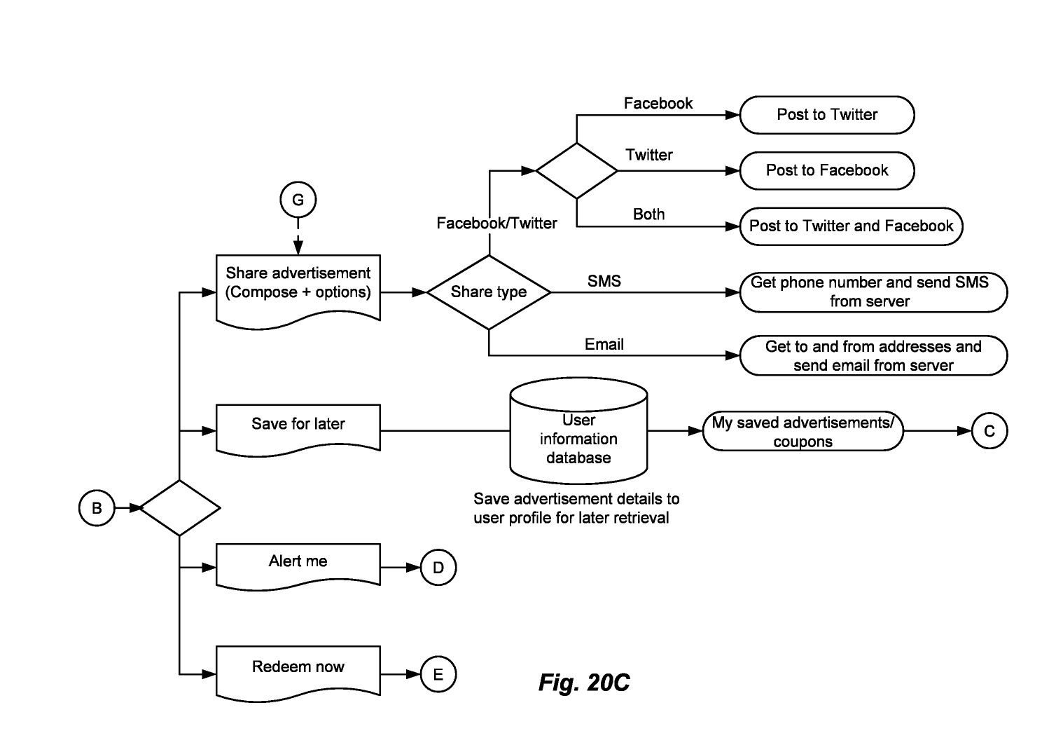

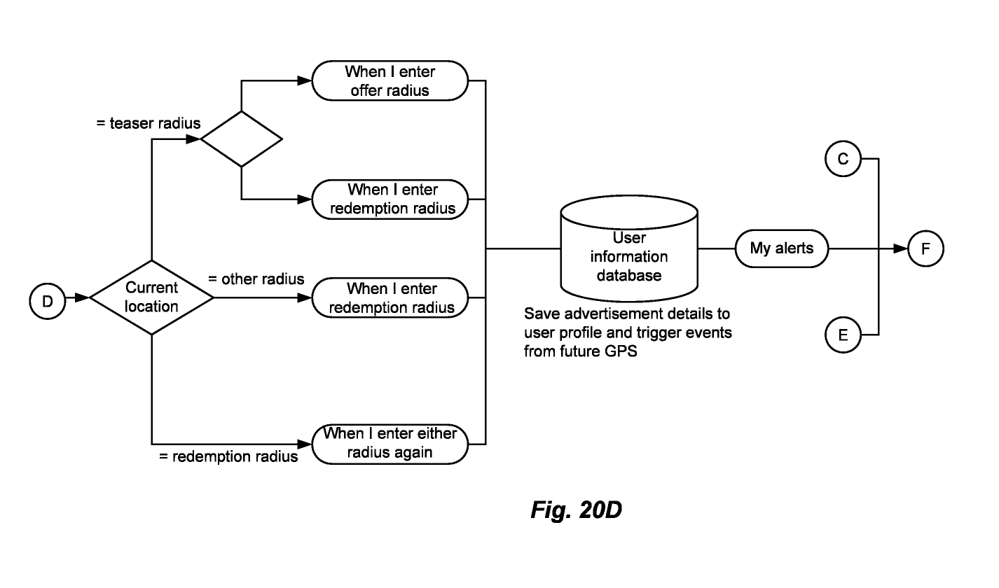

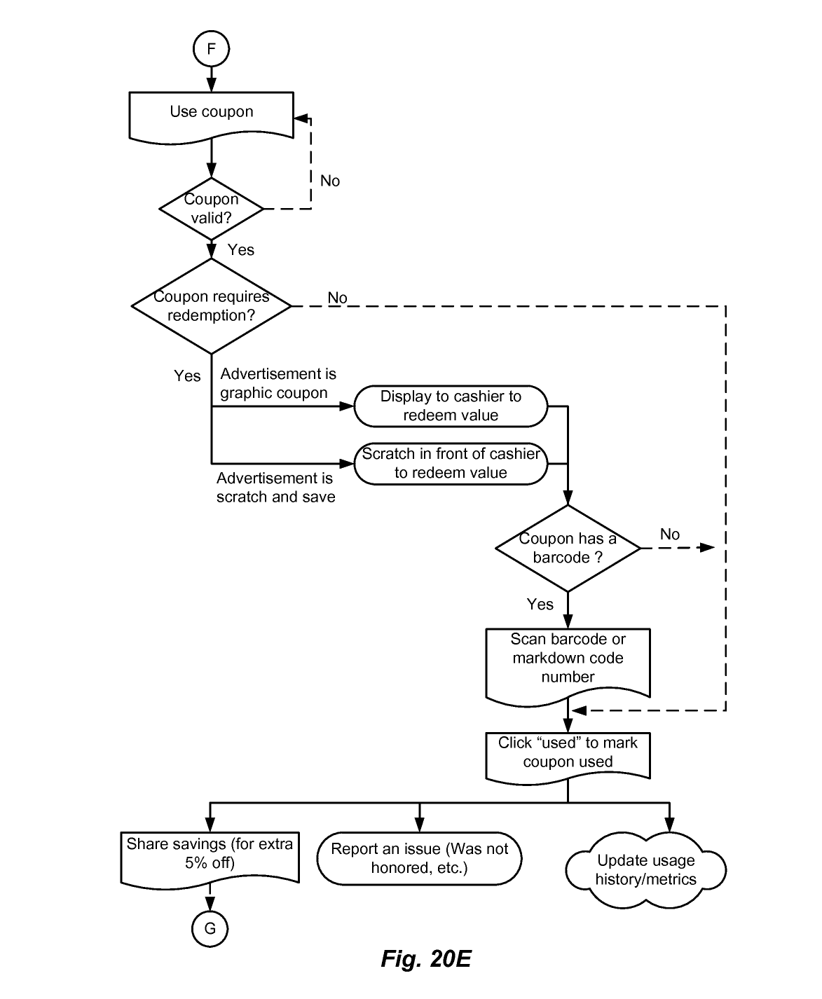

A flow, shown in FIGS. 20A-20E, defines the interaction a user can have with an ad, whether delivered via the SDK or not, and what the outcome said interaction may be.

### Create New Campaign

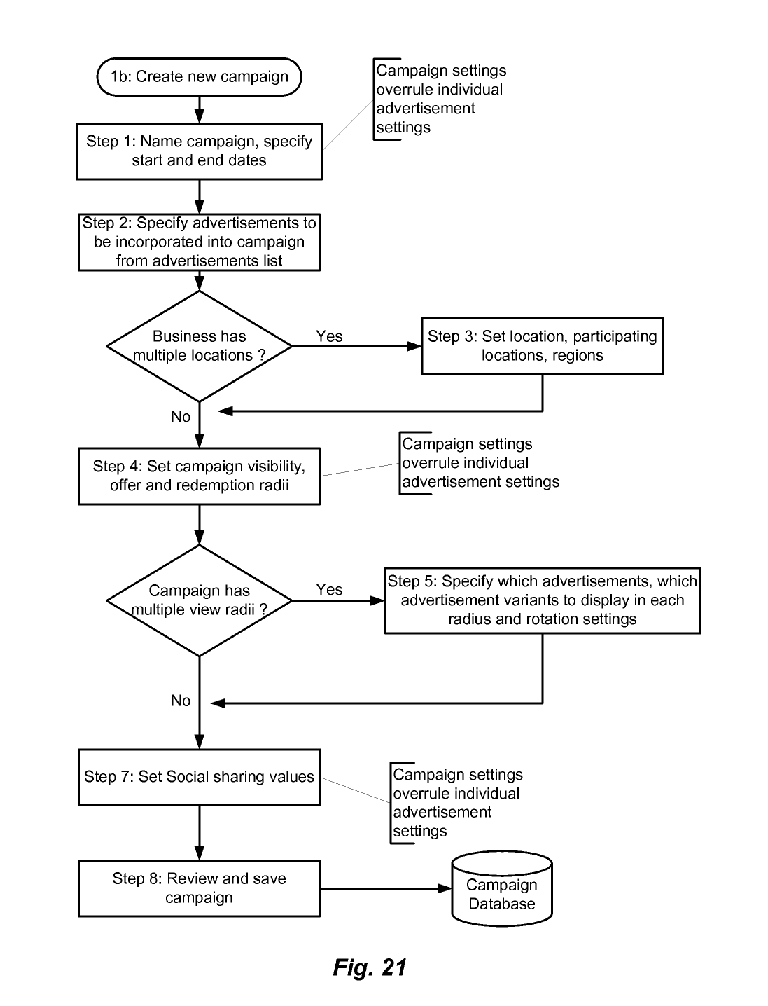

A flow, shown in FIG. 21, defines the process for creating a new ad campaign.

### Create New Ad

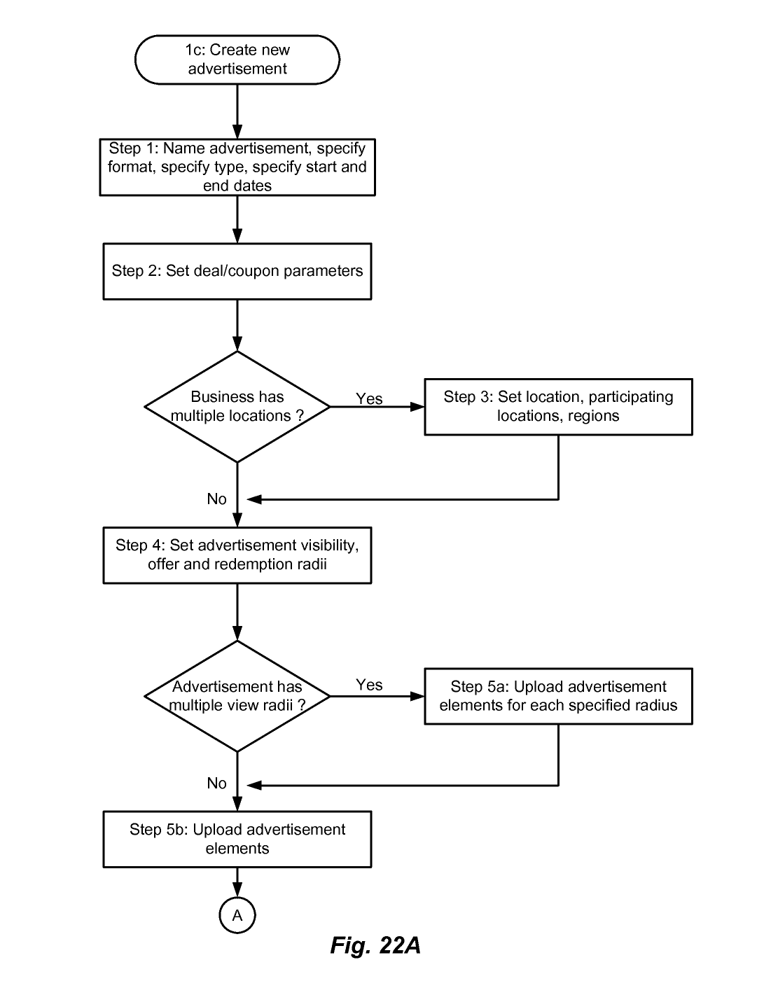

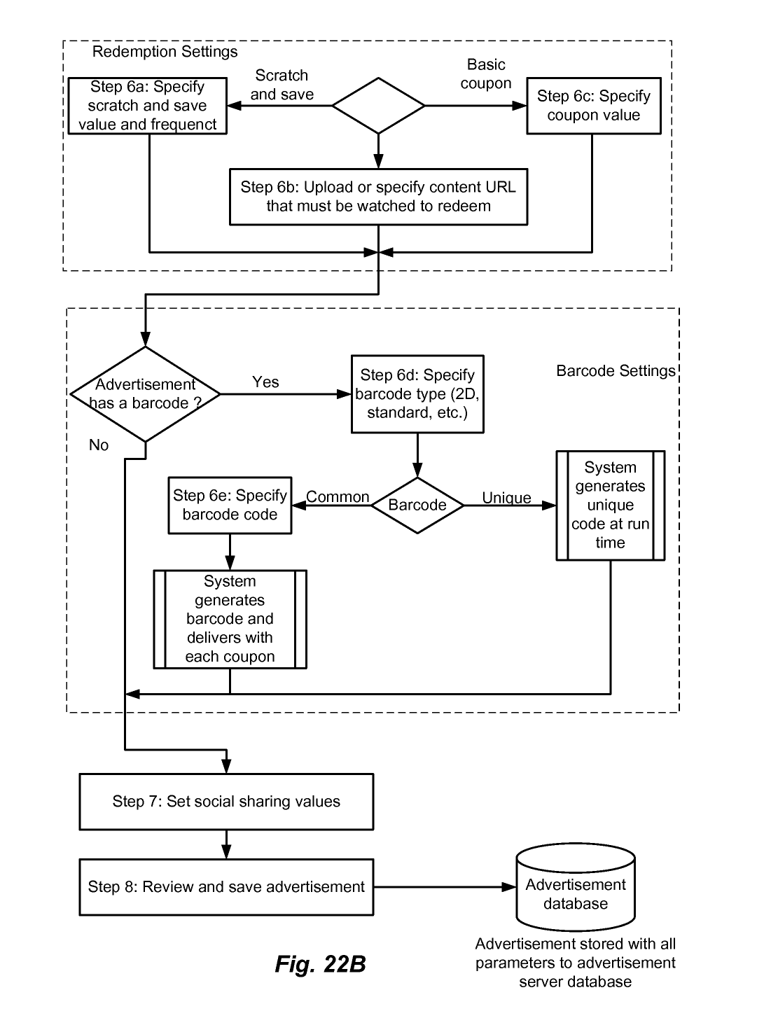

A flow, shown in FIGS. 22A and 22B, defines the process for creating a new ad.

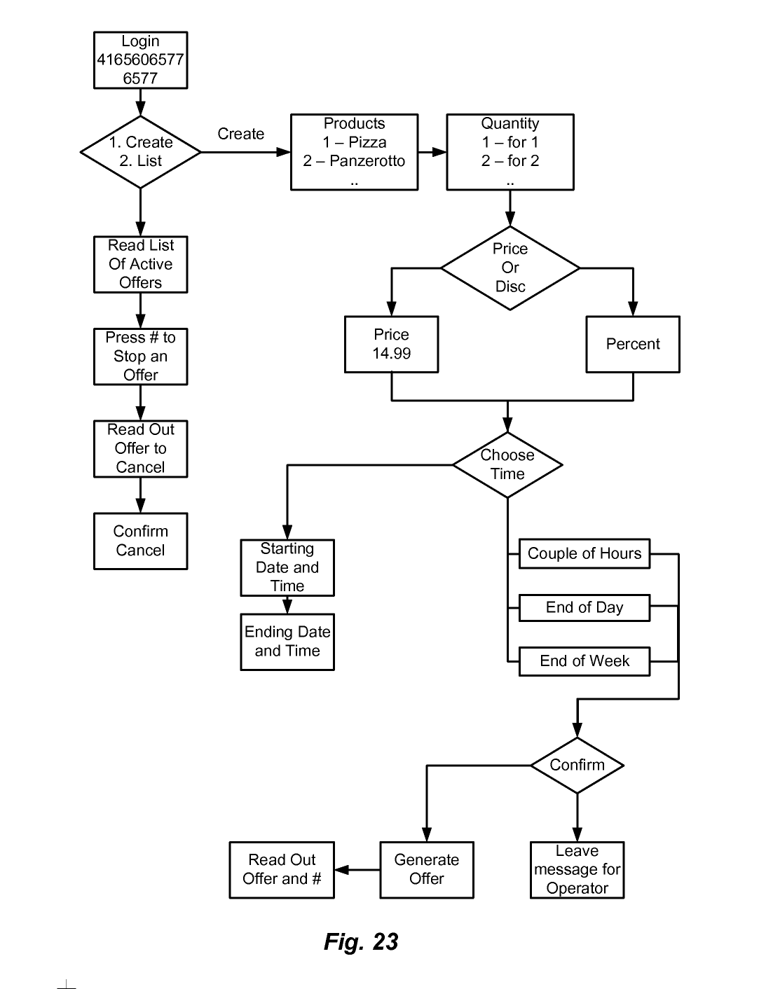

A process flow for creating a new ad using IVR is shown in FIG. 23.

Advertisers can send in advertisements through an SMS message by sending a text to the ad-engines short code (a hypothetical short code is #76968).

### API

Exemplary elements of an API in accordance with embodiments of the present invention are presented below.

Validating a user (user can sign up on the web site at http://www.locoad.com).

HTTP GET

http://api.locoad.com/?phone no=4165433324&code=1800

JSON Response

{“valid”:true, “merchant_id”:14}

For a given merchant id (14 from previous step) find products that the merchant has specified for his offer.

HTTP GET
http://api.locoad.com/merchant/products/?id=14
JSON Response
{
“products”:[

{

“product_id”:1,
“category_id”:5,
“sub_category_id”:1,
“product_description”:“Pizza”,
“tags”:“pizza, italian”

},
{

“product_id”:2,
“category_id”:5,
“sub_category_id”:1,
“product_description”:“Panzerotto”,
“tags”:“panzerotto, italian”

},
{

“product_id”:3,
“category_id”:5,
“sub_category_id”:1,
“product_description”:“Spaghetti”,
“tags”:“spaghetti, italian”

},
{

“product_id”:4,
“category_id”:5,
“sub_category_id”:1,
“product_description”:“Panini”,
“tags”:“panini, italian”

}

]
}

To Place an order for a merchant:

HTTP GET
http://api.locoad.com/merchant/offer/add/?category_id=5&

```
  sub_category_id=1&merchant_id=14&source_id=2&produc
  t_id=1&quantity=2&price=19.99&offer_start=2010-04-
  25
```

00:00:00&offer_end=2010-05-01
JSON Response
{
“offers”:[
{

```
“offer_id”:48,
“merchant_id”:14,
“source”:“1-800”,
“product”:“Pizza”,
“quantity”:2,
“price”:19.99,
“discount_percentage”:0,
“offer_start”:“\/Date(1272168000000-0400)\/”,
“offer end”:“\/Date(1272686400000-0400)\/”,
“img_url”:“http://www.bestfreeicons.com/smimages/
  Pizza%20slice%20icon.png”,
“redemption_code”:“”,
“distance”:0.0,
“merchant_name”:“unopizza”,
“merchant_lat”:43.8026311,
“merchant_lng”:−79.5044929,
“address”:“55 Administration Rd, Vaughan, ON,
  Canada”,
“city”:“Vaughan”,
“postal”:“L4K”,
“state”:“ON”,
“country”:“CA”,
“phone”:4165433324
```

}
]
}

Requesting offers.

HTTP GET
http://api.locoad.com/?lat=43.8&lng=−

79.8&range=1000&page=1&rpp=10&keyword=italian&prefe
rences=pizza,leisure&did={device
id}&appid={publishers App Id}

| | |
|---|---|
| { | “offers” : [ { “address” : “55 Administration Rd, |

Vaughan, ON, Canada”,

“city” : “Vaughan”,
“clickthrough_url” : “http://locoad.com/offer

/?id=12”,

“country” : “CA”,
“discount_percentage” : 0,
“distance” : 14.7382862381124,
“img_url” : “http://i.ehow.com/images/a04/a0/o6 /cook-

healthy-spaghetti-meatballs-dinner-200X200.jpg”,

“merchant_id” : 14,
“merchant_lat” : 43.802631099999999,
“merchant_lng” : −79.504492900000002,
“merchant_name” : “unopizza”,
“offer_end” : “/Date(1280635200000-0400)/”,
“offer_id” : 64,
“offer_start” : “/Date(1277956800000-0400)/”,
“offer_text” : “unopizza 5 Spaghettis for $4,488.00

valid until Aug/1/2010 12:00 AM”,

| | |
|---|---|
| | “phone” : 4165433324, |
| | “postal” : “L4K”, |
| | “price” : 4488.0, |
| | “product” : “Spaghetti”, |
| | “quantity” : 5, |
| | “redemption_code” : “”, |
| | “source” : “1-800”, |
| | “state” : “ON” |
| } | ] } |

Check if the user is within the offer's geo-fenced area.

HTTP GET
http://api.locoad.com/offer/within_range/?id=14&lat=43.8

&lng=−79.8&appid={appid}

JSON Response
{“within_range”:true}

Check if the user is within the offer's geo-fenced redemption area

HTTP GET
http://api.locoad.com/offer/within_redemption_range/?id=

14&lat=43.8&lng=−79.8&appid={appid}

JSON Response
{“within_range”:true}

Throughout the lifetime of the process, various events are registered and tracked through the analytics API. The following events are tracked in regards to the “demand” for offers:

1. Request API—keyword, categories, user preferences, device id, time of request, location etc. (i.e., all of the request parameters)

The following events are tracked in association with the offer:

1. Offer returned in API response

2. Offer displayed

3. Offer displayed within teaser area

4. Offer displayed within offer visibility area

5. Offer displayed within redemption area

6. Offer click-to-web

7. Offer click-to-call

8. Offer click-to-mail

9. Offer click-to-map

10. Offer redeemed (for redemption offers)

11. Offer scratched (for scratch-and-save)

The publisher may be analogized to a local grocery store. The grocery store has a limited supply of shelf space. One of the tasks that grocery store has to solve is to optimize the product that goes onto that shelf space in order to generate the greatest revenue. Application publishers on mobile platforms face a similar problem. The mobile platform is restricted in terms of screen real-estate, and the publisher needs to decide on the optimal revenue generation strategy. For the purposes of analyzing this problem, we disregard the paid apps that do not generate revenue through advertising, as they are not relevant to an advertising engine. Therefore, a free, ad-supported application publisher has to decide what source of advertisement he will use in what space. Once a publisher decides, based on his application layout, what space he is willing to commit to advertisement (analogous to allocating shelf space in the grocery store analogy) he needs to figure out what ad network (or networks) he will use to feed the advertisements to that space. Not having an ad in the allocated advertising space is the equivalent of not having any product on the shelf (and yet the rent is fixed). Therefore, a publisher will strive to embed advertising engines (or mediations engines) that can monetize the allocated space the best through a combination of high CPM, CPA (or whatever monetization method is chosen by the advertising engine) and fill rates. A network effect is at play here. Publishers will go where there is advertising supply, and the advertisers will go where there is advertising demand (i.e., publishers).

Where does this leave a new born, location-based advertising network? Creating an ad SDK that takes up screen space, but does not have enough inventory (low fill-rates), would not be of interest to many advertisers, unless the CPA is unusually high. An alternative way to state this is to say that the CPC/CPA on LBA ads would have to be very high to make up for the lower fill rates due to lack of inventory in a nascent ad engine and inherent lower fill rate due to geo-fencing. A strategy that is often used in this situation is to source lower cost, perhaps not LBA but generic, ads for “back-fill.” Often application publishers perform this task on their own or they use an advertising mediation engine to perform this task on their behalf. So far, most of the location based advertising fulfillment has been born out of location-aware applications' demand directly. Almost all of the bigger location aware apps have their own advertising source. They sell directly to advertisers that wish to target LBA. Most LBA fulfillment has not had to deal with back-fill. The large mobile advertising networks (such as adMob, iAd, etc.) have not targeted this space. Mediation engines have the best opportunity to target the space because they have access to the back-fill.

Thus, if the local offer engine is intended to have an SDK (embeddable component) and therefore occupy screen real-estate at all times, it would either have to have access to the back-fill source or play nicely with other components that might occupy the same space and somehow notify the publisher that there is no inventory and that they should employ some alternative for the back-fill. The offer engine should provide an API by which the publishers can peek to see if there is applicable inventory and if there is inventory the advertising component can be activated or the ad can be constructed by the publisher through the API. This slightly increases the complexity of implementing the ad engine to the publisher.

In the ideal world, the publisher would embed a component from a local ad engine SDK and it would have high fill-rates with high CPAs and an exceptional user experience. However, there are many challenges that are faced by this approach. For example, consider the following scenario: a user is served a scratch-and-save ad. The user does not yet know how much he will save and needs to scratch the ad when he is at the store. He would like to use his phone in the mean-time. This means that he needs to dismiss the ad. Moreover, he might want to use the application that served the ad. However, pushing the application into the background is not an option. Therefore, the user needs to dismiss the ad, as opposed to just hiding it. What happens when user dismisses the ad? Where does it go? Or, put another way, what happens when the user saves the ad? Where is this ad persisted? In addition, how does the user get back to the ad once he gets to the store. In reality, one will have to have an application installed on the user device such as an offer vault, where the user can go back and activate the offers. This has its own challenges. The user has to know that he needs to go that application. The publisher will not be happy with the user leaving his app, etc. Another possibility is to implement the vault as a component that the publisher can embed within his app as well. However, this requires excessive complexity for the publisher implementation. It is preferable that the operating system has an option for saving these types of advertisements in something that is universally accessible.

In one embodiment that makes saving the ad possible, the ad is saved as a bookmark. If the various ad types (redemption type, scratch-and-save, etc.) are then implemented as HTML5 applications, solutions become available, such as where, through the users action, an ad is saved as a bookmark within the user's mobile browser, the user is alerted to this effect on activating the save and, when the user gets to the location for the scratch-and-save offer the user simply opens the bookmark. The browser opens the bookmark, the HTML5 app resolves the user location (which it can, as geo-location is part of the HTML5 spec), the appropriate geo-fencing logic is used (which can be done through geo-location, worker processes and web sockets), the user scratches the virtual scratch-card (which it can do, because of the canvas and Javascript capabilities in HTML5), and all the backend calls in terms of analytics are performed without any issues from the Javascript. An issue with using HTML5 is that it is not available on all platforms. Therefore, the issue can be resolved by implementing the local offer engine app as HTML5 with bookmarks on mobile devices that support HTML5, such as iPhone and Android, and as part of an ad component, such as the Blackberry ad component, for platforms that do not support HTML5.

In addition to bookmarking, other methods may be used for saving an ad and accessing it later, such as after arriving at a target location. For example, a user may click on a button associated with the ad to cause an email message to be sent to the user. The email can contain a URL, and the user can then follow the URL after arriving at the business location to access the saved ad. Similar solutions may be implemented in certain embodiments, including providing a URL via instant messaging systems.

The app vs component issue can be seen even more in the push advertising scenario. In such a scenario, the user subscribes to brands and/or categories for which he/she is interested in receiving ads. In order for push to occur, an application needs to be running on the device, where the application exchanges information with the LBA service to inquire if an ad is available that matches the user's profile. This implies the device at all times executes software that might not be under the control of the publisher. Alternatively, the lookup for ads could happen on demand, such as on user check-in or some other location-associated event within the publisher's application. This implies that the publisher would query for ads that match the user profile by passing the user's location and an identifier that is associated with the user or with the user's device. The identifier is also required in the continuous push scenario, but we assume that by having the app, we can identify the device by having the app have device identification privileges. However, this may pose problems, because there is a need to associate the device with a user account. The publisher might not have the permissions required to obtain such an identifier, and the publisher would be unhappy about having something performing unchecked location queries that are draining the batteries. Moreover, even if there is something running all the time as a component within the publisher's application and there is a match on user's profile for an ad, how is the user supposed to be notified of such an event, especially if he is within some other app?

All of the issues with push are resolved if the push version of the app is an application on its own. It can run at all times, generate push events, give users the ability to set their preferences for what type of ads they wish to receive and act upon the notifications. Thus, push is implemented as an app on its own and does not belong to the scope of the local offer engine. It can utilize the local offer engine through an API to get access to the available LBA inventory, but it should be implemented on its own as an application that does the polling, builds the user demand profile and passes the profile to the local offer engine in a query.

As discussed previously, a set of challenges faces any system that interacts with advertisers that are in the long-tail of the advertiser market. Here we find micro-businesses. These micro-businesses are often interested in hyper-local advertising, since they have perishable goods and services and are in real-world servicing a hyper-local customer base. Unfortunately, the same said businesses often lack the sophistication required to use self-serve advertising systems, even ones as simple as Google's ad-Sense. Every business has access to a phone, be it local or mobile. One of the first steps taken when a business is organized is to get land line telephone service. The local offer engine system was designed to handle this type of market through the use of the IVR system, thereby leveraging a communication medium that is very familiar to a micro-business owner. Within the local offer engine, an account can be pre-created on behalf of a business by a call center. The business's location may be geo-coded, and its product listing can be established based on its line of business. Once signed up, the local business can then place offers through the simple use of the IVR (or a call into a call-centre or through an IVR with voice recognition).

Should local advertisements be pushed or pulled? This is really a wrong question. Push and pull advertisements are different advertisements and can be considered as different options or product lines.

Local push advertising requires having a profile associated with the device or account that has some expressed interest in brands or categories of products, which would then be matched against offers provided by advertisers when the user is within a geo-fenced area associated with the offer. The user's location is acquired on a continuous basis (e.g., using Google Latitude, or Loopt), and alerts are generated when a match on the offers exists.

In pull advertising, the user expresses interest in goods or services through a query or some other action, and at that point in time the query (or context) is passed together with the user's location to pull a matched advertisement from the local offer engine.

Another option is a mixed model, where the user's location is not acquired continuously but instead where a location is acquired through a check-in (or some other location-associated event) and then this location is passed to the location-based system, together with user identifier, so that a match can be made against the offers available in the system.

Push advertising is best accommodated through having a dedicated application for generating the alerts, though server side push could be possible, as long as the user's location is passed to it. A server based push system could be implemented based on the user's approximate location, since it is available to a back-end system through the cell-tower triangulation, but this location is rarely shared with anyone outside of the carrier walls due to privacy concerns. Alternatively, there can be mechanism of continuously providing the user's location (e.g., using a facility such as Xtify service location component on Android, provided by Xtify, Inc., New York, N.Y. 10012). Such service should not activate the GPS since this would drain the battery. Instead, it should use the approximate, lower-power, user location identification using the Wi-Fi access points and cell-tower info. Once the location engine receives the user location, it can perform the matching and activate the platform-specific push notification service. All of the smart phone platforms now have official push notification systems. For example, for Android-based devices, see: http://code.google.com/android/c2dm/. These push notification systems are meant to reduce the amount of power usage required to keep a connection alive and receive a push notification message.

From the system perspective, it is advantageous to separate the push aspect from the offer engine matching. By having an interface between the two systems, it is possible to handle systems where publishers place requests from the offer engine directly by passing a query, a context, a location and user profile information, as well as building on top of this type of interface by creating a push application that passes this type of information to the system and generating alerts on behalf of the user. The publisher or the push application preferably is able to identify the user in a unique fashion in order to pass user-specific information and is able to push notifications to the user.

A push based system, or a system that requires matching on the advertisements based on some kind of user profile, uses a unique user identifier. The identifier does not have to identify a user as a specific person. Personal information can be stripped from the identifier. However, the identifier should identify at least the user's device uniquely. Preferably, the unique identifier can identify the specific user of the device (for the case of multiple users of the phone) and even better if the identifier can exist separately from the device (such as a user account), so that it can be used independently of the device. The disadvantage of having the user sign up is in that it requires the user to take a positive action, namely, signing up. It is possible to use an existing account system, such as Facebook, Connect or Twitter Oauth, to reduce the burden of signing up by the user, but if the offer engine requires such a unique identifier, then any publisher that uses the offer engine would be required to pass such information. It would, therefore, make more sense to have the offer engine be user agnostic and have the user management and user profile be handled by the publisher. If the publisher applications have user preferences, for example if a Facebook account is used and the publisher has access to user likes, such preferences can be passed through the API to the offer engine so that more relevant ads are served. The user identifier (or a hash of such an identifier) should at most be an optional parameter to the offer engine requests.

A system for generating and delivering geo-fenced advertisements has been described as including a processor controlled by instructions stored in a memory. The memory may be random access memory (RAM), read-only memory (ROM), flash memory or any other memory, or combination thereof, suitable for storing control software or other instructions and data. Some of the functions performed by the system for generating and delivering geo-fenced advertisements have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. For example, although some aspects of system for generating and delivering geo-fenced advertisements have been described with reference to a flowchart, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as being limited to the disclosed embodiments.

What is claimed is:

1. A computer-implemented method of displaying a geo-fenced advertisement on a wireless mobile communications device of a user, the advertisement being associated with a business having an associated business location, the method comprising:
automatically receiving information about a geographic location of the mobile communication device;
while the mobile communications device is within a first predefined distance of the business location, automatically causing display, on the mobile communications device, of a first version of the advertisement; and
while the mobile communications device is within a second predefined distance, less than the first predefined distance, of the business location, automatically causing display, on the mobile communications device, of a second version of the advertisement, different than the first version of the advertisement.

2. A method according to claim 1, wherein automatically causing display of the first version of the advertisement comprises automatically causing display of the first version of the advertisement while the mobile communications device is both within the first predefined distance of the business location and at least the second predefined distance from the business location.

3. A method according to claim 1, wherein:
automatically causing display of the first version of the advertisement comprises automatically causing display of the first version of the advertisement only while the mobile communications device is within the first predefined distance of the business location; and
automatically causing display of the second version of the advertisement comprises automatically causing display of the second version of the advertisement only while the mobile communications device is within the second predefined distance of the business location.

4. A method according to claim 1, further comprising, while the mobile communications device is within a predefined redemption area, automatically causing notification of the user of the mobile communications device.

5. A method according to claim 1, further comprising, while the mobile communications device is within the second predefined distance of the business location, automatically revealing, at the mobile communications device, an offer associated with the advertisement.

6. A method according to claim 1, further comprising:
while the mobile communications device is within the second predefined distance of the business location, receiving a signal resulting from a user input on the mobile communication device in association with display of the second version of the advertisement; and
in response to receiving the signal, automatically causing revelation, at the mobile communications device, of an offer associated with the advertisement.

7. A method according to claim 6, wherein:
causing display of the second version of the advertisement comprises causing display, on the mobile communication device, of a virtual scratchcard; and
causing revelation of the offer comprises, in response to the user input, automatically causing alteration of at least a portion of the displayed virtual scratchcard, so as to reveal the offer.

8. A method according to claim 6, wherein automatically causing revelation of the offer comprises revealing the offer only in response to receiving the signal.

9. A method according to claim 6, wherein automatically causing revelation of the offer comprises revealing the offer only in response to receiving the signal while the mobile communications device is within the second predefined distance of the business location.

10. A method according to claim 6, wherein receiving the signal resulting from the user input on the mobile communication device comprises receiving a signal resulting from a wiping gesture performed on the mobile communication device.

11. A method according to claim 6, wherein causing revelation of the offer comprises causing revelation of an offer that is valid only if the user provides an input into the mobile communication device while the mobile communications device is within the second predefined distance of the business location.

12. A method according to claim 1, further comprising:
storing information about the advertisement in a memory of the mobile communications device; and wherein:
automatically causing the display of the second version of the advertisement comprises automatically causing display of the second version of the advertisement in response to the user accessing the stored information about the advertisement.

13. A method according to claim 12, wherein:
storing the information about the advertisement in the memory of the mobile communications device comprises creation of a bookmark in the memory; and
automatically causing display of the second version of the advertisement in response to the user accessing the stored information about the advertisement comprises automatically causing display of the second version of the advertisement in response to the user accessing the bookmark.

14. A method according to claim 1, further comprising:
receiving, by a computer, during an initialization phase, the associated business location and storing the received associated business location in a database;
after the initialization phase, receiving, via an automated telephone interactive voice response (IVR) system, information about at least one of a selected product and a selected service and price information associated with the at least one of the selected product and the selected service;
automatically generating the advertisement using the stored associated business location, the received information about the at least one of the selected product and the selected service and the received associated price information;
storing information about the generated advertisement in the database; and
subsequently using the stored information about the generated advertisement to cause the display of the first and second versions of the advertisement.

15. A tangible, non-transitory computer-readable medium having computer code stored thereon for displaying a geo-fenced advertisement on a wireless mobile communications device of a user, the advertisement being associated with a business having an associated business location, the computer code comprises:
computer code configured to automatically receive information about a geographic location of the mobile communication device;
computer code configured to, while the mobile communications device is within a first predefined distance of the business location, automatically cause display, on the mobile communications device, of a first version of the advertisement; and
computer code configured to, while the mobile communications device is within a second predefined distance, less than the first predefined distance, of the business location, automatically cause display, on the mobile communications device, of a second version of the advertisement, different than the first version of the advertisement.

16. A system for displaying a geo-fenced advertisement on a wireless mobile communications device of a user, the advertisement being associated with a business having an associated business location, the system comprising:
a location module configured to receive information about a geographic location of the mobile communication device;
an advertisement module configured to:
while the mobile communications device is within a first predefined distance of the business location, automatically cause display, on the mobile communications device, of a first version of the advertisement; and
while the mobile communications device is within a second predefined distance, less than the first predefined distance, of the business location, automatically cause display, on the mobile communications device, of a second version of the advertisement, different than the first version of the advertisement.

17. A system according to claim 16, further comprising a notification module configured to automatically cause notification of the user of the mobile communications device, while the mobile communications device is within a predefined redemption area.

18. A system according to claim 16, wherein the advertisement module is configured to automatically reveal, at the mobile communications device, an offer associated with the advertisement, while the mobile communications device is within the second predefined distance of the business location.

19. A system according to claim 16, wherein the advertisement module is configured to:
while the mobile communications device is within the second predefined distance of the business location, receive a signal resulting from a user input on the mobile communication device in association with display of the second version of the advertisement; and
in response to receiving the signal, automatically cause revelation, at the mobile communications device, of an offer associated with the advertisement.

20. A system according to claim 16, wherein the advertisement module is configured to:
store information about the advertisement in a memory of the mobile communications device; and:
automatically cause the display of the second version of the advertisement by automatically causing display of the second version of the advertisement in response to the user accessing the stored information about the advertisement.

21. A system according to claim 16, further comprising an advertisement add module configured to:
receive, during an initialization phase, the associated business location and store the received associated business location in a database; and
after the initialization phase, receive, via an automated telephone interactive voice response (IVR) system, information about at least one of a selected product and a selected service and price information associated with the at least one of the selected product and the selected service; and wherein the advertisement module is configured to:
automatically generate the advertisement using the stored associated business location, the received information about the at least one of the selected product and the selected service and the received associated price information;
store information about the generated advertisement in the database; and
subsequently use the stored information about the generated advertisement to cause the display of the first and second versions of the advertisement.
